(19) United States
(12) Patent Application Publication
(10) Pub. No.: US 2025/0062864 A1
(43) Pub. Date: Feb. 20, 2025

(54) DYNAMIC HYBRID AUTOMATIC REPEAT REQUEST ACKNOWLEDGEMENT (HARQ-ACK) CODEBOOK DETERMINATION

(71) Applicant: Intel Corporation, Santa Clara, CA (US)

(72) Inventors: Yi Wang, Santa Clara, CA (US); Yingyang Li, Santa Clara, CA (US); Gang Xiong, Portland, OR (US)

(21) Appl. No.: 18/723,346

(22) PCT Filed: Feb. 1, 2023
(86) PCT No.: PCT/US2023/061746

§ 371 Date: Jun. 21, 2024

(30) Foreign Application Priority Data
Feb. 2, 2022 (WO) PCT/CN2022/075311
Jun. 29, 2022 (WO) PCT/CN2022/102278

(51) Int. Cl. H04L 1/1867; H04W 72/1273; H04W 72/232

(52) U.S. Cl. CPC H04L 1/1887; H04W 72/1273; H04W 72/232

(57) ABSTRACT

Systems, apparatuses, methods, and computer-readable media are provided for dynamic hybrid automatic repeat request (HARQ)-acknowledgement (ACK) feedback for multi-cell scheduling (e.g., a downlink control information (DCI) that schedules physical downlink shared channels (PDSCHs) and/or physical uplink shared channels (PUSCHs) on multiple cells). Embodiments may include techniques to determine a downlink assignment index (DAI) and/or a HARQ-ACK codebook, e.g., a Type-1. Type-2, and/or Type-3 codebook, for multi-cell scheduling. Other embodiments may be described and claimed.

### CROSS REFERENCE TO RELATED APPLICATION

The present application claims priority to International Patent Application No. PCT/CN2022/075311, which was filed Feb. 2, 2022; and to International Patent Application No. PCT/CN2022/102278, which was filed Jun. 29, 2022.

### FIELD

Various embodiments generally may relate to the field of wireless communications. For example, some embodiments may relate to dynamic hybrid automatic repeat request acknowledgement (HARQ-ACK) codebook determination.

### BACKGROUND

New Radio (NR) supports a wide range of spectrum in different frequency ranges. It is expected that there will be increasing availability of spectrum in the market for 5G Advanced possibly due to re-farming from the bands originally used for previous cellular generation networks. Especially for frequency range 1 (FR1) bands, the available spectrum blocks tend to be more fragmented and scattered with narrower bandwidth. For frequency range 2 (FR2) bands and some FR1 bands, the available spectrum can be wider such that intra-band multi-carrier operation is necessary. To meet different spectrum needs, it is important to ensure that these scattered spectrum bands or wider bandwidth spectrum can be utilized in a more spectral/power efficient and flexible manner, thus providing higher throughput and decent coverage in the network.

### BRIEF DESCRIPTION OF THE FIGURES

FIGS. 1A and 1B illustrate examples of physical downlink control channel (PDCCH)-based downlink assignment index (DAI) and hybrid automatic repeat request acknowledgement (HARQ-ACK) mapping according to a reference cell, in accordance with various embodiments.

FIGS. 2A and 2B illustrate examples of separate HARQ-ACK mapping for each cell scheduled by multi-cell scheduling, in accordance with various embodiments.

FIG. 3 illustrates an example of DAI and HARQ-ACK mapping for Type-2 codebook, in accordance with various embodiments.

FIG. 4 illustrates another example of DAI and HARQ-ACK mapping for Type-2 codebook, in accordance with various embodiments.

FIG. 5A illustrates an example of one DAI in one DCI and HARQ-ACK mapping for different sub-codebooks, in accordance with various embodiments.

FIG. 5B illustrates an example of two DAIs in one DCI and HARQ-ACK mapping for different sub-codebooks, in accordance with various embodiments.

FIG. 6 illustrates a network in accordance with various embodiments.

FIG. 7 schematically illustrates a wireless network 700 in accordance with various embodiments.

FIG. 8 is a block diagram illustrating components, according to some example embodiments, able to read instructions from a machine-readable or computer-readable medium (e.g., a non-transitory machine-readable storage medium) and perform any one or more of the methodologies discussed herein.

FIG. 9 depicts an example procedure for practicing the various embodiments discussed herein.

FIG. 10 depicts another example procedure for practicing the various embodiments.

### DETAILED DESCRIPTION

The following detailed description refers to the accompanying drawings. The same reference numbers may be used in different drawings to identify the same or similar elements. In the following description, for purposes of explanation and not limitation, specific details are set forth such as particular structures, architectures, interfaces, techniques, etc. in order to provide a thorough understanding of the various aspects of various embodiments. However, it will be apparent to those skilled in the art having the benefit of the present disclosure that the various aspects of the various embodiments may be practiced in other examples that depart from these specific details. In certain instances, descriptions of well-known devices, circuits, and methods are omitted so as not to obscure the description of the various embodiments with unnecessary detail. For the purposes of the present document, the phrase “A or B” means (A), (B), or (A and B).

Various embodiments herein may provide techniques for hybrid automatic repeat request (HARQ)-acknowledgement (ACK) feedback for multi-cell scheduling. For example, embodiments may include techniques to determine a downlink assignment index (DAI) and/or a HARQ-ACK codebook, e.g., a Type-1, Type-2, and/or Type-3 codebook, for multi-cell scheduling.

It is desired to increase flexibility and spectral/power efficiency on scheduling data over multiple cells including intra-band cells and inter-band cells. The current scheduling mechanism only allows scheduling of single cell physical uplink shared channel (PUSCH)/physical downlink shared channel (PDSCH) per a scheduling downlink control information (DCI). With more available scattered spectrum bands or wider bandwidth spectrum, there is a need for simultaneous scheduling of multiple cells. To reduce the control overhead, it is beneficial to extend from single-cell scheduling to multi-cell PUSCH/PDSCH scheduling with a single scheduling DCI. More specifically, a DCI is used to schedule PDSCH or PUSCH transmissions in more than one cell or component carrier (CC), where each PDSCH or PUSCH is scheduled in one cell or CC.

Various embodiments herein provide mechanisms for dynamic HARQ-ACK codebook (Type-2 HARQ-ACK codebook) determination for multi-cell scheduling (e.g., for PDSCH). For example, aspects of various embodiments include:
Downlink assignment index (DAI) determination for type-2 HARQ-ACK feedback.
Sub-codebook determination for type-2 HARQ-ACK feedback.

In a NR system, a DCI only schedules a PDSCH or multiple PDSCHs on an active downlink (DL) bandwidth part (BWP) of a cell. For each scheduled PDSCH, UE generates HARQ-ACK codebook and reports HARQ-ACK by PUCCH.

To generate a HARQ-ACK codebook, there can be several different ways. One example is to generate HARQ-ACK codebook according to semi-statically configured parameters, e.g., HARQ-ACK feedback timing K1 set, time domain resource allocation (TDRA) for each serving cell, etc. Such HARQ-ACK codebook is defined as type-1 HARQ-ACK codebook. Another example is to generate HARQ-ACK codebook according to dynamic scheduling, e.g., HARQ-ACK feedback according to received K1 indication (PDSCH-to-HARQ_feedback timing indicator in DCI), Counter Downlink Assignment Index (C-DAI) and Total DAI (T-DAI) in the DCI, etc. Such HARQ-ACK codebook is defined as type-2 HARQ-ACK codebook. Another example is to generate HARQ-ACK codebook according to semi-statically configured HARQ processes and serving cells, which is also known as type-3 HARQ-ACK codebook.

With a DCI for multi-cell scheduling, the DL transmissions on the multiple cells can be scheduled by a single DCI. A transport block (TB) that is scheduled by a DCI for multi-cell scheduling can be only mapped to time/frequency resources on one of the multiple cells. In other words, the PDSCHs on the different cells are considered as different PDSCHs that carry different TBs. For each PDSCH, either one or two TBs can be scheduled.

For a DCI scheduling PDSCH/PUSCH in multiple cells, the PDSCHs/PUSCHs scheduled by a single DCI can be divided into N PDSCH/PUSCH groups. For example, N=2. In a PDSCH/PUSCH group, there can be PDSCH/PUSCHs over one or multiple serving cells. One special example is N=1. In one example, gNB configures N. In another example, N=1 by default.

The multi-cell scheduling DCI format carrying DL assignment may indicate single or N values of K1 slot-offset (PDSCH-to-HARQ_feedback timing indicator) and PUCCH resource indicator (PRI) for transmission of the HARQ-ACK feedback corresponding to each of the scheduled PDSCH group. To determine PUCCH UL slot/sub-slot, K1 slot-offset indicates the slot or sub-slot offset from the slot carrying the corresponding reference PDSCH in the respective scheduled PDSCH groups to corresponding PUCCH carrying HARQ-ACK feedback, or the slot or sub-slot offset from the slot carrying the scheduling PDCCH for multi-cell scheduling to corresponding PUCCH carrying HARQ-ACK feedback.

For type-2 HARQ-ACK codebook (dynamic CB), UE generates HARQ-ACK for each PDSCH according to indicated K1 value in each DCI scheduling the PDSCH and downlink assignment indicator (DAI) in the DCI. The DCI can schedule single PDSCH, or schedule multiple PDSCHs on multiple cells.

In the following, for DAI determination and sub-codebook determination, for a DCI format which supports multi-cell scheduling, and if the DCI format only schedules single cell, then the DCI is considered to be single-cell scheduling. For a DCI format which only supports single cell scheduling (the DCI format does not support multi-cell scheduling), the DCI is considered to be single-cell scheduling.

### DAI Determination

In one embodiment, for Type 2 HARQ-ACK CB, the multi-cell scheduling DCI format may indicate single value of C-DAI and T-DAI to indicate the respective locations of the corresponding HARQ-ACK bits in the HARQ-ACK CB. HARQ-ACK for the PDSCHs are mapped to same HARQ-ACK codebook. DAI in the DCI is determined by the reference serving cell index. For this case, the multi-cell scheduling DCI format carrying DL assignment may indicate a single K1 slot-offset and PRI value for transmission of the HARQ-ACK feedback.

In one option, a value of C-DAI field in DCI formats denotes the accumulative number of {serving cell, PDCCH monitoring occasion}-pair(s) in which PDSCH reception(s), SPS PDSCH release or SCell dormancy indication associated with the DCI formats is present up to the current reference serving cell and current PDCCH monitoring occasion. For example, C-DAI is counted
first, if the UE supports for more than one PDSCH reception on a serving cell that are scheduled from a same PDCCH monitoring occasion, in increasing order of the PDSCH reception starting time for the same {reference serving cell, PDCCH monitoring occasion} pair,
second in ascending order of reference serving cell index, and
third in ascending order of PDCCH monitoring occasion index m, where 0≤m<M.

For a DCI without scheduling PDSCH for any cell, e.g., SPS release or SCell dormancy indication, the reference serving cell is the serving cell in which PDCCH is received. In one example, the DCI format for multi-cell scheduling can not be used without scheduling PDSCH. In another example, the DCI format for multi-cell scheduling can be used without scheduling PDSCH, only if the multi-cell scheduling DCI format schedules a single cell, e.g., the carrier indicator bit field indicates single cell. In another example, the DCI format for multi-cell scheduling can be used without scheduling PDSCH, if the multi-cell scheduling DCI schedules a single or multiple cells.

For a single-cell scheduling DCI for PDSCH, the reference serving cell is the serving cell in which PDSCH is received.

For a multi-cell scheduling DCI for PDSCH, the reference serving cell is a cell of multiple cells scheduled by the single DCI. The reference serving cell is determined according to at least one of the following mechanisms:
the reference cell is serving cell for a reference PDSCH to determine UL slot for PUCCH
   If there are more than one reference PDSCH to determine UL slot for PUCCH, select one of the cell as the reference cell, according to a specific cell index, or according to specific starting or ending position as below.
the reference cell is selected according to a specific cell index, e.g.,
   the scheduled cell with lowest cell index, or,
   the scheduled cell with lowest cell index within a PDSCH group, or
   the scheduled cell with lowest cell index within a reference PDSCH group,
the reference cell is selected according to a specific starting or ending position, e.g.,
   the scheduled cell with the last-ending PDSCH based on the time domain resource allocation (TDRA) bit-field in the DCI and/or SCS.
   the scheduled cell with a PDSCH the earliest starting symbol based on the time domain resource allocation (TDRA) bit-field in the DCI and/or SCS.
   If two PDSCHs have aligned starting and/or ending symbol, the reference cell is selected according to a specific cell index as provided above.
the reference cell is configured by higher-layer

For multiple PDSCHs scheduling by a DCI, the PDSCHs are associated with same C-DAI. The HARQ-ACK bits for the multiple PDSCHs is placed according to a pre-defined rule, e.g., according to cell index order.

If the UE supports for more than one PDSCH reception on a serving cell that are scheduled from a same PDCCH monitoring occasion, and at least one PDSCH reception is scheduled by multi-cell scheduling DCI and the serving cell is the reference serving cell for multi-cell scheduling, DAI is counted in increasing order of the PDSCH reception starting time for the same {reference serving cell, PDCCH monitoring occasion} pair.

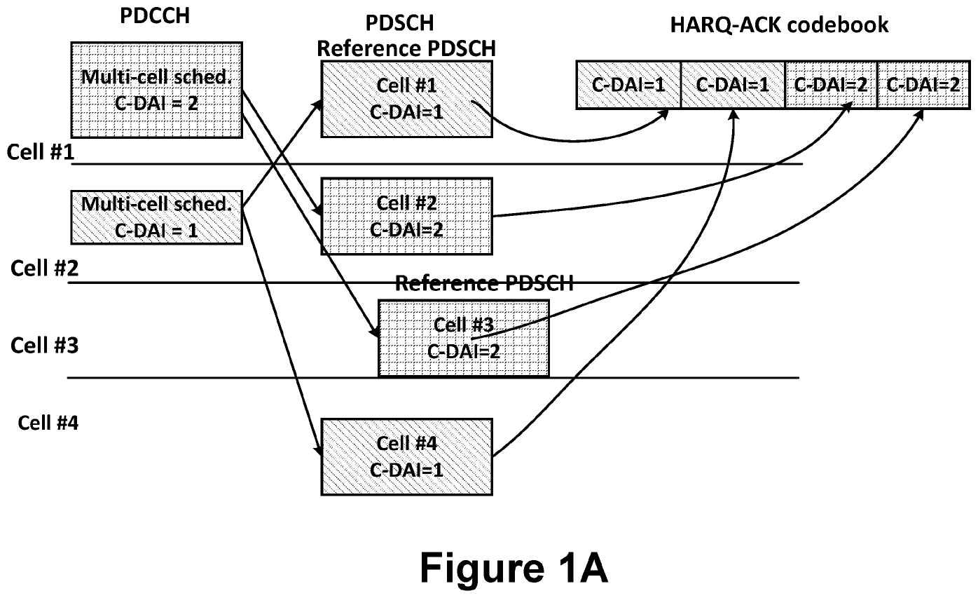

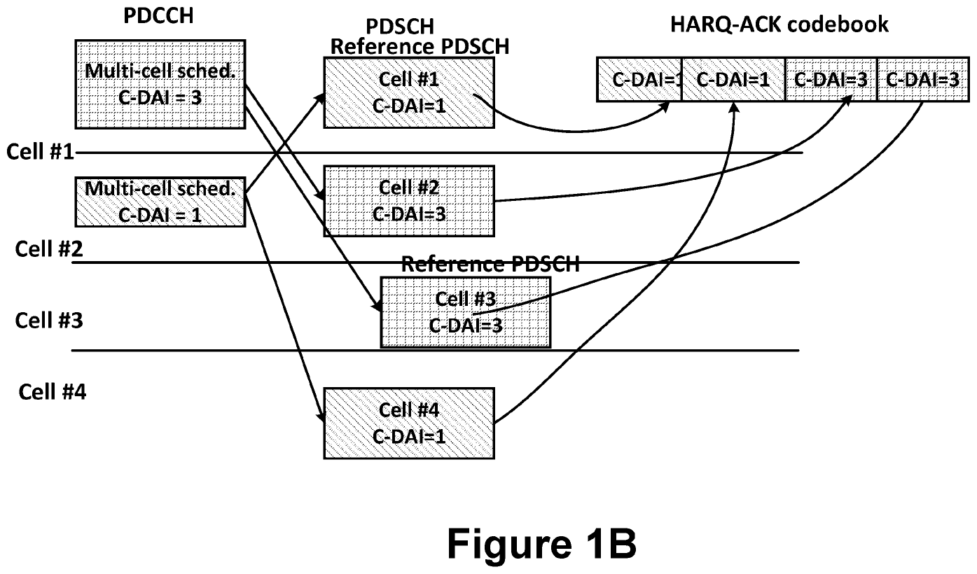

FIG. 1A provides an example. For a DCI, the reference cell is the cell of reference PDSCH to determine UL slot for PUCCH. If more than one reference PDSCH, the cell with lowest cell index for the reference PDSCH is the reference cell. For PDCCH on serving cell 1, the reference serving cell is cell #3, for PDCCH on serving cell 2, the reference serving cell is cell #1. Then, DAI is counted for PDCCHs in ascending order of reference serving cell index, so, DAI in PDCCH on serving cell 1 is 2, and DAI in PDCCH on serving cell 2 is 1. For C-DAI=1, HARQ-ACK for PDSCH on cell 1 is placed before HARQ-ACK for PDSCH on cell 4. For C-DAI=2, HARQ-ACK for PDSCH on cell 2 is placed before HARQ-ACK for PDSCH on cell 3.

In one example, the reference cell is chosen from scheduled cells without consideration of valid or invalid PDSCH on the scheduled cell. In another example, the reference cell is chosen only within the scheduled cells with valid PDSCH.

In another option, a value of C-DAI field in DCI formats denotes the accumulative number of PDSCH reception(s), SPS PDSCH release or SCell dormancy indication associated with the DCI formats is present up to the current reference serving cell or the 1st cell scheduled with the current reference serving cell by the same DCI and current PDCCH monitoring occasion.

For multiple PDSCHs scheduling by a DCI, the HARQ-ACK bits for the PDSCHs is ordered according to a pre-defined rule, e.g., according to cell index order.

FIG. 1B provides an example. For a DCI, the reference cell is the cell of reference PDSCH to determine UL slot for PUCCH. If more than one reference PDSCH, the cell with lowest cell index for the reference PDSCH is the reference cell. For PDCCH on serving cell 1, the reference serving cell is cell #3, for PDCCH on serving cell 2, the reference serving cell is cell #1. Then, DAI is counted for PDSCHs in ascending order of reference serving cell index, so, DAI in PDCCH on serving cell 1 is 3 (because there're two PDSCHs associated with PDCCH on serving cell 2), and DAI in PDCCH on serving cell 2 is 1. For C-DAI=1, HARQ-ACK for PDSCH on cell 1 is placed before HARQ-ACK for PDSCH on cell 4. For C-DAI=3, HARQ-ACK for PDSCH on cell 2 is placed before HARQ-ACK for PDSCH on cell 3.

In an embodiment, for Type 2 HARQ-ACK CB (dynamic CB), the multi-cell scheduling DCI format may indicate N values of C-DAI and T-DAI to indicate the respective locations of the corresponding HARQ-ACK bits in the HARQ-ACK CB. Further, note that in this case, the HARQ-ACK for all PDSCHs within the same PDSCH group is associated with same HARQ-ACK CB, but the HARQ-ACK bits for different PDSCH groups may not necessarily be mapped to the same HARQ-ACK CB. That is, the HARQ-ACK bits may be carried in different PUCCHs, depending on the K1-slot offset value, relative numerologies of the DL serving cells and the PUCCH cell, Time Domain Resource Allocation (TDRA) for the respective PDSCH group.

If HARQ-ACK of N PDSCH groups are associated with the same HARQ-ACK CB, DAIs counts for PDSCHs within same codebook. DAI for each PDSCH group is ordered according to PDSCH group index, or according to the reference cell within each PDSCH group index. For example, if the reference cell index in PDSCH group 1 is larger than reference cell index in PDSCH group 2, DAI for PDSCH group 2 is 1, and DAI for PDSCH group 1 is 2.

If HARQ-ACK of N PDSCH groups are associated with different HARQ-ACK CB, DAI counts PDSCHs for each codebook respectively.

In one option, C-DAI and T-DAI could be separately indicated for the multiple PDSCH groups scheduled by the DCI. If the PDSCHs associated with each C-DAI is associated with different HARQ-ACK codebook, or different HARQ-ACK sub-codebook, C-DAI is separately counted within each codebook or sub-codebook.

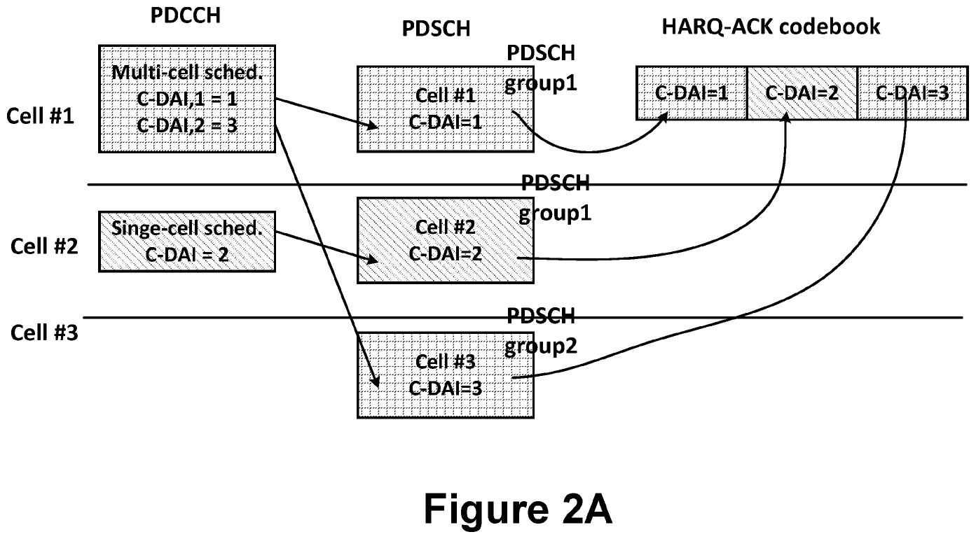

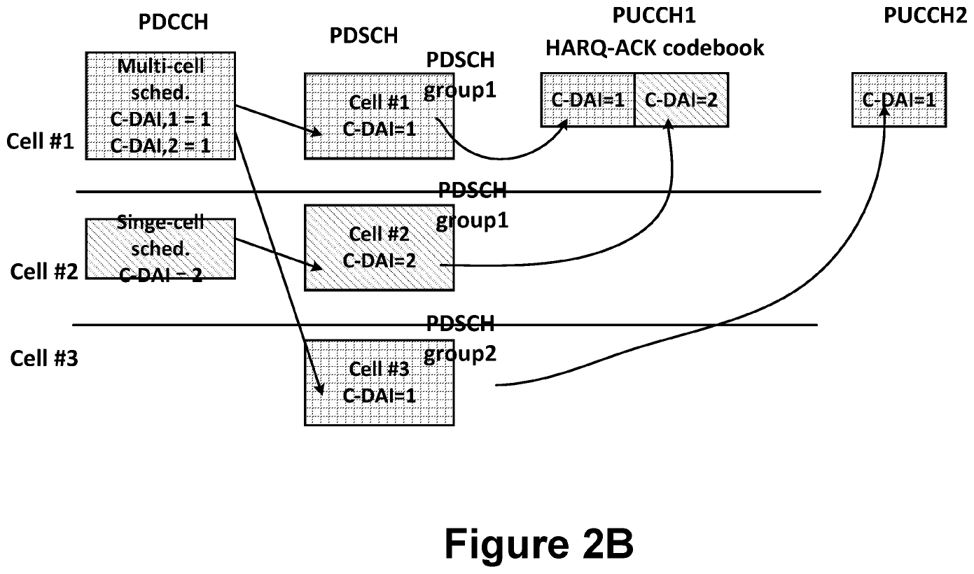

For example, as shown in FIG. 2A, two cells with inconsecutive cell indexes #1 and #3 are scheduled by a DCI for multi-cell scheduling, and these two cells are associated with the same PUCCH for HARQ-ACK feedback. Separate C-DAI are indicated to the PDSCHs on the two cells on two PDSCH groups, otherwise, UE may not know there is another PDSCH on cell #2 scheduled by other DCI. The two PDSCHs scheduled by the DCI for multi-cell scheduling have C-DAI equals to 1 and 3, and the PDSCH on cell #2 uses C-DAI equals to 2. The HARQ-ACK for the PDSCH on cell #1 is put at the first position in the HARQ-ACK codebook, which is followed by the HARQ-ACK for the HARQ-ACK for the PDSCH on cell #2. The HARQ-ACK for the PDSCH on cell #3 is put at the last position in the HARQ-ACK codebook.

For example, as shown in FIG. 2B, two cells with inconsecutive cell indexes #1 and #3 are scheduled by a DCI for multi-cell scheduling, and these two cells are associated with different PUCCH for HARQ-ACK feedback. Separate C-DAI are indicated to the PDSCHs on the two cells on two PDSCH groups. The two PDSCHs scheduled by the DCI for multi-cell scheduling have C-DAI equals to 1 and 1, and the PDSCH on cell #2 uses C-DAI equals to 2. The HARQ-ACK for the PDSCH on cell #1 is put at the first position in the HARQ-ACK codebook, which is followed by the HARQ-ACK for the HARQ-ACK for the PDSCH on cell #2, in PUCCH1. The HARQ-ACK for the PDSCH on cell #3 is put at the first position in the HARQ-ACK codebook in PUCCH2.

In one option, C-DAI could be separately indicated for the multiple PDSCHs scheduled by the DCI, while a single T-DAI is signaled in the DCI for multi-cell scheduling. Corresponding to a transmission of the DCI, T-DAI may be incremented by taking all the PDSCHs associated with the same PUCCH into account.

Further, in an example, the earliest symbol of the PUCCH or PUSCH transmission carrying the corresponding HARQ-ACK feedback should be no earlier than T symbols from the end of the PDSCH that ends latter, considering any impact from timing advance, where T symbols time duration is determined based on the applicable minimum UE processing time for PDSCH processing following the appropriate UE processing time capability. If different UE capabilities on PDSCH processing time are configured on multiple cells, the UE capability with longer processing time may apply.

### CBG or TB-Based Transmission for Multi-Cell Scheduling

In one embodiment, if a UE is configured with multi-cell scheduling, and the UE is configured with type-2 codebook, UE does not expect to be configured with CBG-based transmission for all the cells associated with multi-cell scheduling. Alternatively, if a UE is configured with multi-cell scheduling, and the UE is configured with type-2 codebook, UE does not expect to be configured with CBG-based transmission for any cell within the same PDSCH group or PUCCH group. Alternatively, if a UE is configured with multi-cell scheduling, and the UE is configured with type-2 codebook, UE does not expect to be configured with CBG-based transmission for all any cell within the same PDSCH group. Alternatively, if a UE is configured with multi-cell scheduling, UE does not expect to be configured with CBG-based transmission for any cell associated with multi-cell scheduling. Alternatively, if a UE is configured with multi-cell scheduling, UE does not expect to be configured with CBG-based transmission for any cell within the same PDSCH group or PUCCH group. Therefore, for a candidate PDSCH location for a cell which can be scheduled by multi-cell scheduling, HARQ-ACK is reported per TB, or bundled multiple TBs of a PDSCH, e.g., if spatial bundling is configured.

In another embodiment, a PDSCH on a cell scheduled by a DCI for multi-cell scheduling could use CBG-based transmission. For a candidate PDSCH location, the number of HARQ-ACK bits Nc is determined by the maximum configured number of CBGs. HARQ-ACK is reported per CBG.

In another embodiment, a PDSCH on a cell scheduled by a DCI for multi-cell scheduling could only use TB-based transmission, no matter CBG-based transmission is configured for the cell or BWP or not. If CBG-based transmission is configured for the BWP for single cell scheduling, for a candidate PDSCH location, the number of HARQ-ACK bits Nc is determined by the maximum configured number of CBGs. If the PDSCH is scheduled by TB-based transmission, HARQ-ACK is reported per TB and the HARQ-ACK is repeated, or NACK is padded until Nc bits. Alternatively, for a candidate PDSCH location which is the interaction of both single and multi-cell scheduling, the number of HARQ-ACK bits Nc is determined by the maximum configured number of CBGs, and for a candidate PDSCH location only for multi-cell scheduling, the number of HARQ-ACK bits Nc is determined by the configured number of TBs for a PDSCH.

In another embodiment, whether CBG based transmission applies to a PDSCH on a cell scheduled by a DCI for multi-cell scheduling is configured by high layer signaling. The configuration could be common to all cells that could be scheduled by a DCI for multi-cell scheduling. Alternatively, the configuration could be common to all cells within the same PDSCH group. Alternatively, the configuration is separately configured for each cell that is schedulable by a DCI for multi-cell scheduling, therefore, it allows one cell with CBG-based transmission and the other cell with TB-based transmission. Further, the maximum number of CBGs for a TB scheduled by a DCI for multi-cell scheduling could be configured by high layer signaling.

In one embodiment, a common configuration of the number of TB (codeword) applies to both multi-cell scheduling and single-cell scheduling for a DL BWP of a cell. Alternatively, the number of TB scheduled by a DCI for multi-cell scheduling for a DL BWP of a cell could be separately configured from the number of TB scheduled by a DCI for single cell scheduling of the cell. Alternatively, the number of TB scheduled by a DCI for multi-cell scheduling for a cell could be configured per UE or per serving cell.

### Multi-PDSCH Scheduling for Multi-Cell Scheduling

Multi-PDSCH scheduling means one DCI schedules multiple PDSCHs in the same serving cell.

In one embodiment, if a UE is configured with multi-cell scheduling, and the UE is configured with type-2 codebook, UE does not expect to be configured with multi-PDSCH scheduling for any cell associated with multi-cell scheduling. Alternatively, if a UE is configured with multi-cell scheduling, and the UE is configured with type-2 codebook, UE does not expect to be configured with multi-PDSCH scheduling for any cell within the same PDSCH group or PUCCH group. Alternatively, if a UE is configured with multi-cell scheduling, UE does not expect to be configured with multi-PDSCH scheduling for any cell associated with multi-cell scheduling. Alternatively, if a UE is configured with multi-cell scheduling, UE does not expect to be configured with multi-PDSCH scheduling for any cell within the same PDSCH group or PUCCH group.

Note that the above embodiments may also apply for the case for multi-PUSCH scheduling and multi-cell scheduling. In other words, if a UE is configured with multi-cell scheduling, UE does not expect to be configured with multi-PUSCH scheduling for any cell associated with multi-cell scheduling or all the cells within a PUCCH group or PUSCH group.

In another embodiment, if a UE is configured with multi-cell scheduling, the UE can be configured with multi-PDSCH/PUSCH scheduling, but the UE does not expect to be scheduled for multi-cell scheduling and multi-PDSCH scheduling by the same DCI, e.g., UE can be configured with DCI 1-1 for multi-PDSCH scheduling and DCI 1-3 for multi-cell scheduling.

### Sub-Codebook Determination

In one embodiment, for Type 2 HARQ-ACK CB. HARQ-ACK for PDSCH scheduled by single-cell scheduling and HARQ-ACK for PDSCHs scheduled by multi-cell scheduling is in the same sub-codebook.

If at least one serving cells within a PUCCH group is configured with CBG, there can be more than one HARQ-ACK sub-codebooks. One sub-codebook is for HARQ-ACK for PDSCH scheduled by single-cell scheduling for TB transmission and HARQ-ACK for PDSCHs scheduled by multi-cell scheduling for TB transmission, another one sub-codebook is for HARQ-ACK for PDSCH scheduled by single-cell scheduling for CBG transmission, and HARQ-ACK for PDSCHs scheduled by multi-cell scheduling for CBG transmission.

If at least one serving cell within a PUCCH group are configured with multi-PDSCH scheduling, there can be more than one HARQ-ACK sub-codebooks. One sub-codebook is for HARQ-ACK for PDSCH scheduled by multi-PDSCH scheduling, and another sub-codebook is for HARQ-ACK for PDSCH not scheduled by multi-PDSCH scheduling, e.g., PDSCH scheduled by single-cell scheduling without multi-PDSCH scheduling and HARQ-ACK for PDSCHs scheduled by multi-cell scheduling.

In one option, a DAI counts the number of PDCCHs within same sub-codebook. For each PDCCH within the same sub-codebook, the number of HARQ-ACK bits is determined by the maximum number of HARQ-ACK bits for single-cell scheduling and multiple-cell scheduling in the same sub-codebook.
If TB based HARQ-ACK feedback is used for the multiple PDSCHs scheduled by a DCI for multi-cell scheduling, a unit of number of HARQ-ACK bits N_{TB}^{max} equals to the maximum number of N_{TB,2}^{tot,max} and N_{TB,1}^{max} among all cells, where, the total maximum configured number of TBs for the multiple PDSCHs scheduled by a DCI for multi-cell scheduling is N_{TB,2}^{tot,max} the maximum number of TBs of a PDSCH scheduled by a DCI for single-cell scheduling is N_{TB,1}^{max}. Therefore, for a PDSCH scheduled by a DCI for single-cell scheduling or the multiple PDSCHs scheduled by a DCI for multi-cell scheduling, the number of reported HARQ-ACK bits are N_{TB}^{max} bits. The total maximum configured number of TBs for the multiple PDSCHs scheduled by a DCI for multi-cell scheduling is determined by the number of PDSCHs scheduled by a multi-cell scheduling DCI (e.g., the maximum number of PDSCHs for each row in the cell index table for multi-cell scheduling). Alternatively, the total maximum configured number of TBs for the multiple PDSCHs scheduled by a DCI for multi-cell scheduling is determined by the total number of PDSCHs/serving cells configured for a multi-cell scheduling DCI (e.g., the union of all rows in the cell index table for multi-cell scheduling). The definition of the total maximum configured number of TBs for the multiple PDSCHs scheduled by a DCI for multi-cell scheduling can be applicable to all embodiments in this document. If the spatial bundling is configured (e.g., harq-ACK-SpatialBundlingPUCCH is configured), it is assumed the number of configured TBs per PDSCH is 1.
If CBG based HARQ-ACK feedback is used for at least a PDSCH of the multiple PDSCHs scheduled by a DCI for multi-cell scheduling, a unit of number of HARQ-ACK bits N_{CBG}^{max} for the sub-codebook for CBG equals to the maximum number of N_{CBG,2}^{tot,max} and N_{CBG,1}^{max} among all cells, where, the total maximum configured number of CBGs for the multiple PDSCHs scheduled by a DCI for multi-cell scheduling is N_{CBG,2}^{tot,max}, the maximum number of CBGs of a PDSCH scheduled by a DCI for single-cell scheduling is N_{CBG,1}^{max}. Therefore, for a PDSCH scheduled by a DCI for single-cell scheduling or the multiple PDSCHs scheduled by a DCI for multi-cell scheduling, the number of reported HARQ-ACK bits are N_{CBG}^{max} bits. For multi-cell scheduling, if one PDSCH uses TB-base transmission, one CBG per TB could be effectively assumed for the TB-based PDSCH transmission.

If at least one serving cell within a PUCCH group are configured with multi-PDSCH scheduling, the number of HARQ-ACK bits for each PDCCH within the sub-codebook for HARQ-ACK for PDSCH not scheduled by multi-PDSCH scheduling is determined as provided above, and the number of HARQ-ACK bits for each PDCCH within the sub-codebook for HARQ-ACK for PDSCH scheduled by multi-PDSCH scheduling is determined as below:
a unit of number of HARQ-ACK bits N_{TBG}^{max} for the sub-codebook for multi-PDSCH scheduling equals to the maximum number of configured TBs of multiple PDSCHs or multiple PDSCH bundling groups scheduled by a DCI for multi-PDSCH scheduling among all cells, e.g., N_{TBG}^{max} is the maximum value between N_{TB,c}^{DL}·N_{HARQ-ACK,c}^{TBG,max} across all N_{cells}^{DL,TBG} serving cells if the UE is provided numberOfHARQ-BundlingGroups, and N_{TB,c}^{DL}·N_{PDSCH,c}^{max} across all N_{cells}^{DL,TBG} cells serving cells where the UE is configured with multi-PDSCH but not provided numberOfHARQ-BundlingGroups, and N_{TB,c}^{DL} is the value of maxNrofCode WordsScheduledByDCI for serving cell c if harq-ACK-SpatialBundlingPUCCH is not provided; else, N_{TB,c}^{DL}=1.

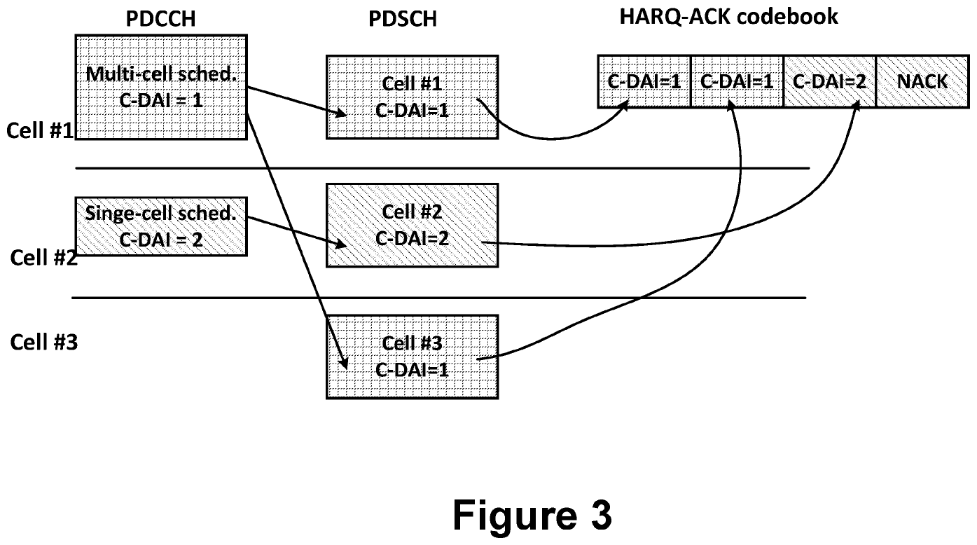

For example, as shown in FIG. 3, two cells with inconsecutive cell indexes #1 and #3 are scheduled by a DCI for multi-cell scheduling. A single C-DAI are indicated to the two PDSCHs on the two cells, e.g. C-DAI=1. On the other hand, a C-DAI equals to 2 is assigned to another PDSCH on cell #2. To generate HARQ-ACK codebook, the HARQ-ACK for multiple PDSCHs scheduled by the DCI for multi-cell scheduling are concatenated and mapped to a position in the HARQ-ACK codebook according to reference cell index, e.g., first map HARQ-ACK for PDSCH on cell #1 (reference cell) and cell #3, and then map the HARQ-ACK for the PDSCH on cell #2. HARQ-ACK for the PDSCH on cell #1 is 2 bits, 1 bit is valid HARQ-ACK for the PDSCH, 1 bit is NACK as padding bits, to ensure 2 bits per C-DAI, assuming the maximum number of HARQ-ACK bits per DAI is 2 bits.

In one example, if the number of scheduled PDSCHs by a DCI is less than the maximum number of PDSCHs scheduled by a DCI, the HARQ-ACK for scheduled PDSCHs are first consecutively mapped, and NACKs are appended until the maximum number of HARQ-ACK bits. For example, one row in the cell index table for multi-cell scheduling includes cell 2,3,4 and another row in the cell index table includes cell 1 and cell 3, and single TB is configured without CBG. Assuming the total maximum configured number of TBs for the multiple PDSCHs scheduled by a DCI for multi-cell scheduling is determined by the number of PDSCHs scheduled by a multi-cell scheduling DCI at a time, N_{TB}^{max}=3. If a DCI schedules cell 1 and cell 3, HARQ-ACK for cell 1 and cell 3 is place in 1^{st} and 2^{nd} bit location, and 1 bit NACK is added in 3rd bit location. In another example, if the number of scheduled PDSCHs by a DCI is less than the maximum number of PDSCHs scheduled by a DCI, the HARQ-ACK for scheduled PDSCHs are mapped for the bit location according to serving cell index, and NACKs are added in the remaining bit locations. For example, one row in the cell index table for multi-cell scheduling includes cell 1,2,3, 4 and another row in the cell index table includes cell 1 and cell 3, and single TB is configured without CBG. Assuming the total maximum configured number of TBs for the multiple PDSCHs scheduled by a DCI for multi-cell scheduling is determined by the number of PDSCHs scheduled by a multi-cell scheduling DCI at a time, N_{TB}^{max}=4, if a DCI schedules cell 1 and cell 3, HARQ-ACK for cell 1 and cell 3 is place in 1^{st} and 3^{rd} bit location. while NACKs are added in 2^{nd} and 4^{th} bit location.

In another option, DAI counts PDSCHs, or DAI counts serving cells within same sub-codebook. For each PDCCH within the same sub-codebook, the number of HARQ-ACK bits varies with the actually scheduled or transmitted number of PDSCHs or valid PDSCHs. In this scheme, a single C-DAI value x is included in the DCI for multi-cell scheduling, however, C-DAI values x . . . x+Np−1 are effectively used by the Np PDSCHs scheduled by the DCI. A next DCI transmitted by the gNB could indicate C-DAI value x+Np.
If TB based HARQ-ACK feedback is used for the multiple PDSCHs scheduled by a DCI for multi-cell scheduling, a unit of number of HARQ-ACK bits N_{TB}^{max} equals to the maximum number of N_{TB,2}^{max} and N_{TB,1}^{max} among all cells, where, the maximum configured number of TBs for a PDSCH scheduled by a DCI for multi-cell scheduling is N_{TB,2}^{max}, the maximum number of TBs of a PDSCH scheduled by a DCI for single-cell scheduling is N_{TB,1}^{max}. Therefore, for a PDSCH scheduled by a DCI for single-cell scheduling, the number of reported HARQ-ACK bits are N_{TB}^{max} bits. On the other hand, for the multiple PDSCHs scheduled by a DCI for multi-cell scheduling, the total number of reported HARQ-ACK bits are Nₚ N_{TB}^{max} bits.
If CBG based HARQ-ACK feedback is used for at least one of the multiple PDSCHs scheduled by a DCI for multi-cell scheduling, a unit of number of HARQ-ACK bits V_{CBG}^{max} equals to the maximum number of N_{CBG,2}^{max}, and N_{CBG,1}^{max} among all cells, where, the maximum configured number of CBGs for a PDSCH scheduled by a DCI for multi-cell scheduling is N_{CBG,2}^{max}, the maximum number of CBGs of a PDSCH scheduled by a DCI for single-cell scheduling is N_{CBG,1}^{max}. Therefore, for a PDSCH scheduled by a DCI for single-cell scheduling, the number of reported HARQ-ACK bits are N_{CBG}^{max} bits. On the other hand, for the multiple PDSCHs scheduled by a DCI for multi-cell scheduling, the total number of reported HARQ-ACK bits are Nₚ N_{CBG}^{max} bits. For multi-cell scheduling, if one PDSCH uses TB-base transmission, one CBG per TB could be effectively assumed for the TB-based PDSCH transmission.

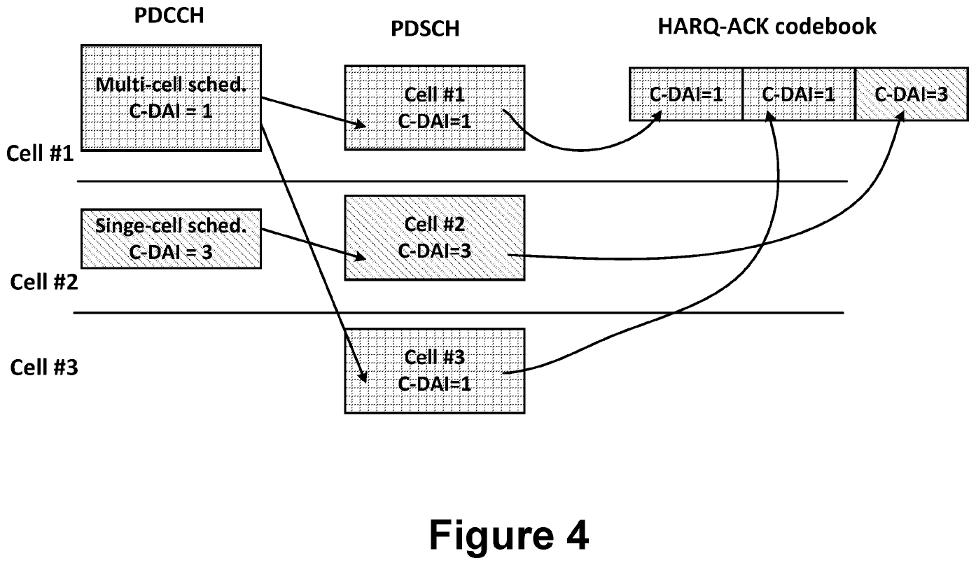

For example, as shown in FIG. 4, two cells with inconsecutive cell indexes #1 and 3 are scheduled by a DCI for multi-cell scheduling. A single C-DAI are indicated in the DCI, e.g., C-DAI=1. C-DAI applies to the PDSCH on cell #1, and effectively C-DAI=2 applies to the PDSCH on cell #3. Therefore, a C-DAI equals to 3 is assigned to another PDSCH on cell #2. To generate HARQ-ACK codebook, the HARQ-ACK for the two PDSCHs scheduled by the DCI for multi-cell scheduling are concatenated and mapped to a position in the HARQ-ACK codebook according to the reference cell index, e.g., first map HARQ-ACK for PDSCH on cell #0 (reference cell) and cell #3, and then map the HARQ-ACK for the PDSCH on cell #2.

In one embodiment, for Type 2 HARQ-ACK CB, HARQ-ACK for a PDSCH scheduled by single-cell scheduling and HARQ-ACK for PDSCHs scheduled by multi-cell scheduling is in different sub-codebook. That is, one sub-codebook is for HARQ-ACK for PDSCH scheduled by single-cell scheduling, and another sub-codebook is for HARQ-ACK for PDSCHs scheduled by multi-cell scheduling. Note that in case of multi-cell scheduling, if actually number of scheduled PDSCHs or transmitted PDSCHs is 1, the HARQ-ACK sub-codebook is based on HARQ-ACK sub-codebook for PDSCH scheduled by single-cell scheduling.

In one option, if CBG based transmission is not configured, one sub-codebook is for HARQ-ACK for PDSCH scheduled by single-cell scheduling, and another sub-codebook is for HARQ-ACK for the PDSCHs scheduled by multi-cell scheduling.

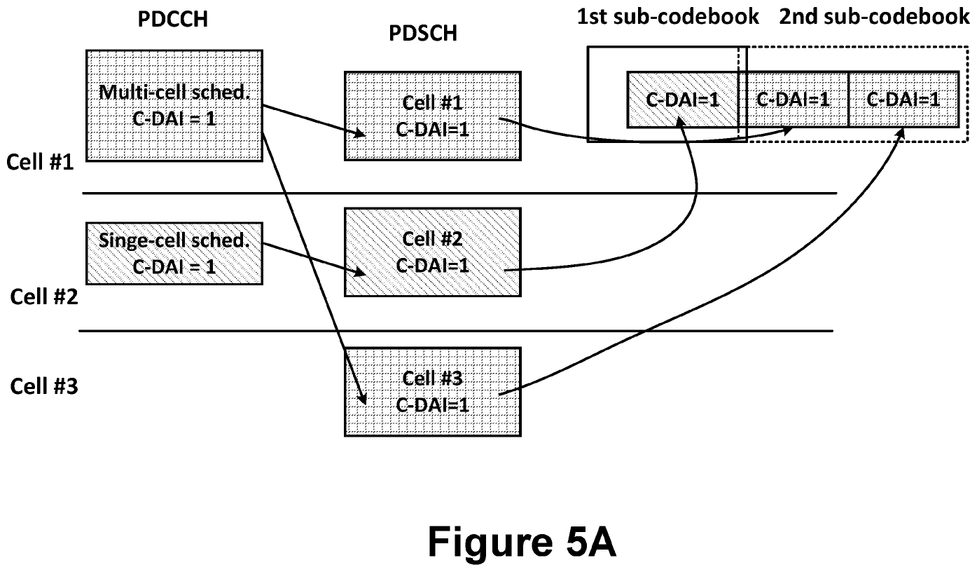

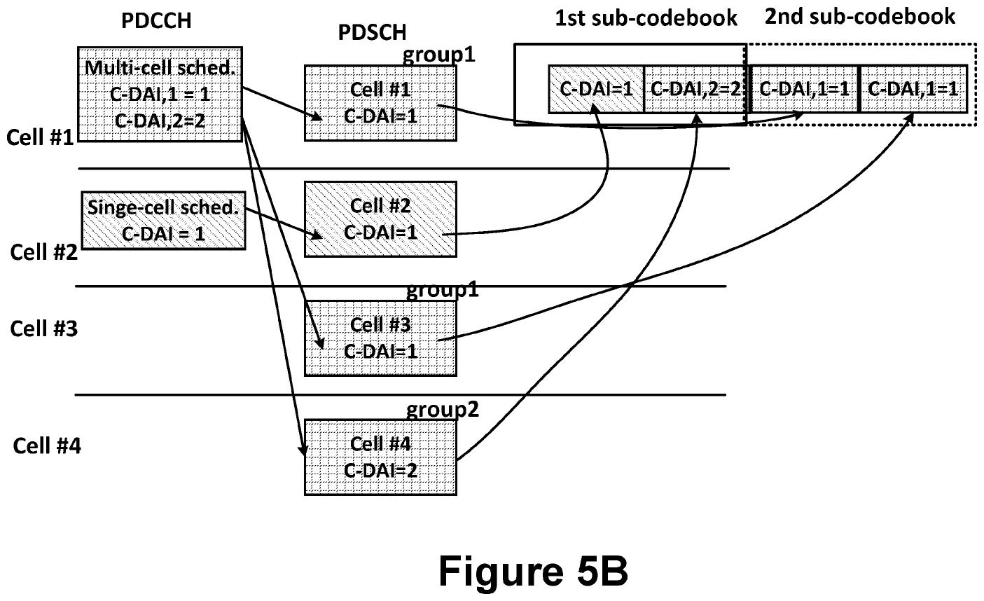

FIG. 5A provides an example. In one DCI, there is one C-DAI, which applies to all PDSCHs scheduled by this DCI. Two cells with inconsecutive cell indexes #1 and #3 are scheduled by a DCI for multi-cell scheduling. A single C-DAI are indicated in the DCI, e.g., C-DAI=1. C-DAI applies to the PDSCH on cell #1 and the PDSCH on cell #3. On the other hand, a C-DAI equals to 1 is assigned to another PDSCH on cell #2. To generate HARQ-ACK codebook, 1^{st} sub-codebook is for single cell scheduling, e.g., PDSCH on cell #2, 2^{nd} sub-codebook is for multi-cell scheduling, the HARQ-ACK for the two PDSCHs scheduled by the DCI for multi-cell scheduling are concatenated and mapped to a position in the HARQ-ACK. It is noted that, if the maximum number of HARQ-ACK bits per DAI for 2^{nd} sub-codebook is larger than 2, UE should generate NACK until the maximum number of HARQ-ACK bits.

FIG. 5B provides an example. In one DCI, there are two C-DAIs for two PDSCH groups, each C-DAI applies to all PDSCHs within one PDSCH group scheduled by this DCI. Three cells with inconsecutive cell indexes #1, #3 and #4 are scheduled by a DCI for multi-cell scheduling, #1 and #3 is in PDSCH group 1 and #4 is in PDSCH group 2. Therefore, DAI, 1 applies to both #1 and #3, and DCI,2 applies to #2. One cell with cell index #2 is scheduled by a DCI for single cell scheduling, and DAI in the DCI applies to the PDSCH on #2.

HARQ-ACK for PDSCH on cell #2 and cell #4 belong to 1^{st} sub-codebook due to single cell scheduling, and HARQ-ACK for PDSCH on cell #1 and cell #3 belong to 2^{nd} sub-codebook due to multi-cell scheduling. Therefore, C-DAI, 1 and C-DAI,2 are separately counted for 2^{nd} and 1^{st} sub-codebook, though all PDSCHs are associated with the same PUCCH. C-DAI for #2 and C-DAI,2 for #4 and are consecutively counted within 1^{st} sub-codebook with DAI=1 and DAI=2 respectively. Therefore, HARQ-ACK codebook includes 1^{st} sub-codebook with HARQ-ACK for PDSCH on cell #1 and cell #3, and 2^{nd} sub-codebook with HARQ-ACK for PDSCH on cell #2 and cell #4, respectively.

In another option, if CBG based transmission is not configured for a DCI for multi-cell scheduling, whether HARQ-ACK for the PDSCHs scheduled by multi-cell scheduling is in the same sub-codebook with HARQ-ACK for the PDSCH scheduled by single-cell scheduling is determined by the number of TBs scheduled by the DCI. For example, if only two TBs are carried by the two PDSCHs, HARQ-ACK for the PDSCHs scheduled by multi-cell scheduling and HARQ-ACK for the PDSCH scheduled by single-cell scheduling is in the same sub-codebook. Otherwise, different sub-codebooks are used respectively. In another option, if CBG based transmission is not configured for a DCI for multi-cell scheduling, whether HARQ-ACK for the PDSCHs scheduled by multi-cell scheduling is in the same sub-codebook with HARQ-ACK for the PDSCH scheduled by single-cell scheduling is configured by higher-layer signaling.

In another option, if at least one serving cells within a PUCCH group is configured with CBG, there can be more than one HARQ-ACK sub-codebooks. One sub-codebook is for HARQ-ACK for PDSCH scheduled by single-cell scheduling for TB transmission, and another sub-codebook is for HARQ-ACK for PDSCHs scheduled by multi-cell scheduling for TB transmission and HARQ-ACK for PDSCHs with CBG transmission. Or, one sub-codebook is for HARQ-ACK for PDSCH scheduled by single-cell scheduling for TB transmission, and another sub-codebook is for HARQ-ACK for PDSCHs scheduled by multi-cell scheduling for TB transmission, and another sub-codebook is HARQ-ACK for PDSCH scheduled by single-cell scheduling for with CBG transmission, and another sub-codebook is HARQ-ACK for PDSCHs scheduled by multi-cell scheduling for with CBG transmission. Or, one sub-codebook is for HARQ-ACK for PDSCH scheduled by single-cell scheduling for TB transmission, and another sub-codebook is for HARQ-ACK for PDSCHs scheduled by multi-cell scheduling for TB transmission, and another sub-codebook is HARQ-ACK for PDSCH with CBG transmission.

In another option, if multi-PDSCH scheduling is not configured for any cell within a PDSCH group or PUCCH group, one sub-codebook is for HARQ-ACK for PDSCH scheduled by single-cell scheduling, and another sub-codebook is for HARQ-ACK for the PDSCHs scheduled by multi-cell scheduling. If at least one cell within a PDSCH group or PUCCH group is configured with multi-PDSCH scheduling, one sub-codebook is for HARQ-ACK for PDSCH scheduled by single-cell scheduling without multi-PDSCH scheduling, another sub-codebook is for HARQ-ACK for the PDSCHs scheduled by multi-cell scheduling and PDSCHs scheduled by multi-PDSCH scheduling. Alternatively, one sub-codebook is for HARQ-ACK for PDSCH scheduled by single-cell scheduling without multi-PDSCH scheduling, another sub-codebook is for HARQ-ACK for the PDSCHs scheduled by multi-cell scheduling, and another sub-codebook PDSCHs scheduled by multi-PDSCH scheduling.

DAI counts the number of PDCCHs within same sub-codebook. For each PDCCH within the same sub-codebook, the number of HARQ-ACK bits is determined by the maximum number of HARQ-ACK bits for a PDCCH in the same sub-codebook.

For example, if none of serving cells within a PUCCH group is configured with CBG, 1^{st} sub-codebook is for HARQ-ACK for PDSCH scheduled by single-cell scheduling, and 2^{nd} sub-codebook is for HARQ-ACK for PDSCHs scheduled by multi-cell scheduling. For 2^{nd} sub-codebook, the number of HARQ-ACK bits per PDCCH is N_{TB}^{max} N_{TB}^{max} equals to the total maximum number of configured TBs of the multiple PDSCHs scheduled by a DCI for multi-cell scheduling. For example, N_{TB}^{max}=N_{cell}^{max}*N_{TB,2}^{max}, where N_{cell}^{max} is the maximum number of PDSCHs scheduled by a DCI for multi-cell scheduling (e.g., the maximum number of PDSCHs for each row in the cell index table for multi-cell scheduling) or the total number of serving cells configured for multi-cell scheduling (e.g., the union of all rows in the cell index table for multi-cell scheduling), and N_{TB,2}^{max} is the maximum configured number of TBs for a PDSCH scheduled by a DCI for multi-cell scheduling. If at least one serving cell within a PUCCH group is configured with two codewords for multi-cell scheduling, e.g., maxNrofCodeWordsScheduledByDCI=2 and spatial bundling is not configured, N_{TB,2}^{max}=2, otherwise, N_{TB,2}^{max}=1. Assuming a UE is configured with 4 DL CCs, and gNB configures 3 sets of PDSCHs scheduled by a single DCI. 1^{st} set includes DL serving cell 1 and DL serving cell 2, 2^{nd} set includes DL serving cell 3 and DL serving cell 4, 3^{rd} set includes DL serving cell 2, serving cell 3 and serving cell 4. DL serving cell 1 is configured with 2 codeword, and DL CC 2,3,4 is configured with 1 codeword respectively. Then, N_{cell}^{max}=3, e.g., N_{cell}^{max} is the maximum number of PDSCHs scheduled by a DCI for multi-cell scheduling and N_{TB,2}^{max}=2. Alternatively, N_{cell}^{max}=4, e.g., N_{cell}^{max} is the total number of serving cells configured for multi-cell scheduling and N_{TB,2}^{max}=2. Alternatively, N_{TB}^{max}=max (Σᵢ₌₁^{N}^{_{p,j}}N_{TB,2}^{i,j}), where N_{p,j} is the number of scheduled PDSCHs for j-th set of PDSCHs, N_{TB,2}^{i,j} is the maximum configured number of TBs for i-th PDSCH of j-th set of PDSCHs. If there can be multiple DCI formats for multi-cell scheduling, the sets of PDSCHs that can be scheduled by any of the multiple DCI formats for multi-cell scheduling need to be considered on the determination of N_{TB}^{max}, e.g., j is a row in the cell index table defined for any of multi-cell scheduling DCI formats. Still, assuming a UE is configured with 4 DL CCs, and gNB configures 3 sets of PDSCHs scheduled by a single DCI. 1^{st} set includes DL serving cell 1 and DL serving cell 2, 2^{nd} set includes DL serving cell 3 and DL serving cell 4, 3^{rd} set includes DL serving cell 2, serving cell 3 and serving cell 4. DL serving cell 1 is configured with 2 codeword, and DL CC 2,3,4 is configured with 1 codeword respectively. For 1^{st} set, the total number of TBs of all PDSCHs in 1^{st} set is Σᵢ₌₁^{N}^{_{p,1}}N_{TB,2}^{i,1}=N_{TB,2}^{1,1} (DL serving cell 1)+N_{TB,2}^{2,1} (DL serving cell 2)=3. For 2^{nd} set, the total number of TBs of all PDSCHs in 2^{nd} set is Σᵢ₌₁^{N}^{_{p,2}}N_{TB,2}^{i,2}=N_{TB,2}^{1,2} (DL serving cell 3)+N_{TB,2}^{2,2} (DL serving cell 4)=2. For 3^{rd} set, the total number of TBs of all PDSCHs in 3^{rd} set is Σᵢ₌₁^{N}^{_{p,3}}N_{TB,2}^{i,3}=N_{TB,2}^{1,3} (DL serving cell 2)+N_{TB,2}^{2,3} (DL serving cell 3)+N_{TB,2}^{2,3} (DL serving cell 4)=3. Therefore, N_{TB}^{max}=max (Σᵢ₌₁^{N}^{_{p,j}}N_{TB,2}^{i,j})=max (3,2,3)=3. Alternatively, N_{TB}^{max}=max (Σᵢ₌₁^{N}^{ₚ}^{,k}N_{TB,2}^{i,k}), where N_{p,k} is the total number of serving cells configured for k-th DCI format for multi-cell scheduling, and N_{TB,2}^{i,k} is the maximum configured number of TBs for i-th PDSCH/i-th serving cell configured for k-th DCI format for multi-cell scheduling. Then, for the same example above, k=1. N_{TB}^{max}=N_{TB,2}¹ (DL serving cell 1)+N_{TB,2}² (DL serving cell 2)+N_{TB,2}³ (DL serving cell 3)+N_{TB,2}⁴ (DL serving cell 4)=5.

For 1^{st} sub-codebook, the number of HARQ-ACK bits per PDCCH is N_{TB,1}^{max}. N_{TB,1}^{max} is the maximum number of TBs of a PDSCH scheduled by a DCI for single-cell scheduling among all cells. N_{TB,1}^{max}=2 if two codewords is configured for at least one serving cell within a PUCCH group, e.g., maxNrofCodeWordsScheduledByCDI=2 and spatial bundling is not configured, otherwise, N_{TB,1}^{max}=1.

For another example, if at least one serving cell within a PUCCH group is configured with CBG, 1^{st} sub-codebook is for HARQ-ACK for PDSCH scheduled by single-cell scheduling, and 2^{nd} sub-codebook is for HARQ-ACK for PDSCHs scheduled by multi-cell scheduling and HARQ-ACK for PDSCHs with CBG transmission. Then, for 2^{nd} sub-codebook, the number of HARQ-ACK bits per PDCCH is N_{CBG}^{max}, N_{CBG}^{max} equals to the maximum number of N_{CBG,2}^{tot,max} and N_{CBG,1}^{max} among all cells, where, N_{CBG,1}^{max} is the maximum number of CBGs of a PDSCH scheduled by a DCI for single-cell scheduling, N_{CBG,2}^{tot,max} is the total maximum configured number of CBGs for the multiple PDSCHs scheduled by a DCI for multi-cell scheduling if CBG is supported for multi-cell scheduling (if some cell of multi-cell is configured with TB while some cell of multi-cell is configured with CBG, the number of TB for the cell configured with TB is treated as the number of CBGs for N_{CBG,2}^{tot,max}), or, N_{CBG,2}^{tot,max} is N_{TB}^{max} the total maximum number of configured TBs for the multiple PDSCHs scheduled by a DCI for multi-cell scheduling, if CBG is not supported for multi-cell scheduling.

For another example, if at least one serving cell within a PUCCH group is configured with multi-PDSCH scheduling, 1^{st} sub-codebook is for HARQ-ACK for PDSCH scheduled by single-cell scheduling without multi-PDSCH scheduling, and 2^{nd} sub-codebook is for HARQ-ACK for PDSCHs scheduled by multi-cell scheduling and HARQ-ACK for PDSCHs with multi-PDSCH scheduling. Then, for 2^{nd} sub-codebook, the number of HARQ-ACK bits per PDCCH is N_{TBG &TB}^{max}, N_{TBG &TB}^{max} equals to the maximum number of N_{TB}^{max} and N_{TBG}^{max} among all cells, where, N_{TB}^{max} equals to the total maximum number of configured TBs of multiple PDSCHs scheduled by a DCI for multi-cell scheduling among all cells provided above, N_{TBG}^{max} equals to the maximum number of configured TBs of multiple PDSCHs or multiple PDSCH bundling groups scheduled by a DCI for multi-PDSCH scheduling among all cells. This may apply for the case when singe TB or 2 TBs are configured and scheduled for PDSCHs with multi-cell or multi-PDSCH scheduling.

For another example, if at least one serving cell within a PUCCH group is configured with multi-PDSCH scheduling, 1^{st} sub-codebook is for HARQ-ACK for PDSCH scheduled by single-cell scheduling without multi-PDSCH scheduling, and 2^{nd} sub-codebook is for HARQ-ACK for PDSCHs scheduled by multi-cell scheduling, and 3^{rd} sub-codebook is for HARQ-ACK for PDSCHs with multi-PDSCH scheduling. Then, for 2^{nd} sub-codebook, the number of HARQ-ACK bits per PDCCH is N_{TB}^{max} as provided above, and for 3^{rd} sub-codebook, the number of HARQ-ACK bits per PDCCH is N_{TB}^{max} as provided above.

If the expected number of HARQ-ACK bits per PDCCH determined according to any of the method above is larger than the number of HARQ-ACK bits with valid HARQ-ACK values per PDCCH, UE transmits valid HARQ-ACK bits and padding bits. The bit ordering of the valid HARQ-ACK bits and padding bits is determined according to at least one of the methods below:
First map the valid HARQ-ACK bits consecutively (e.g., from smaller serving cell index to larger serving cell index), and then, add padding bits until the expected number of HARQ-ACK bits per PDCCH.
First map the valid HARQ-ACK bits into the bit location associated with corresponding serving cell index, and then, add padding bits to the unmapped bit locations until the expected number of HARQ-ACK bits per PDCCH.

The valid HARQ-ACK is associated with valid PDSCHs, or valid HARQ-ACK is associated with scheduled PDSCHs according to the received DCI.

### Systems and Implementations

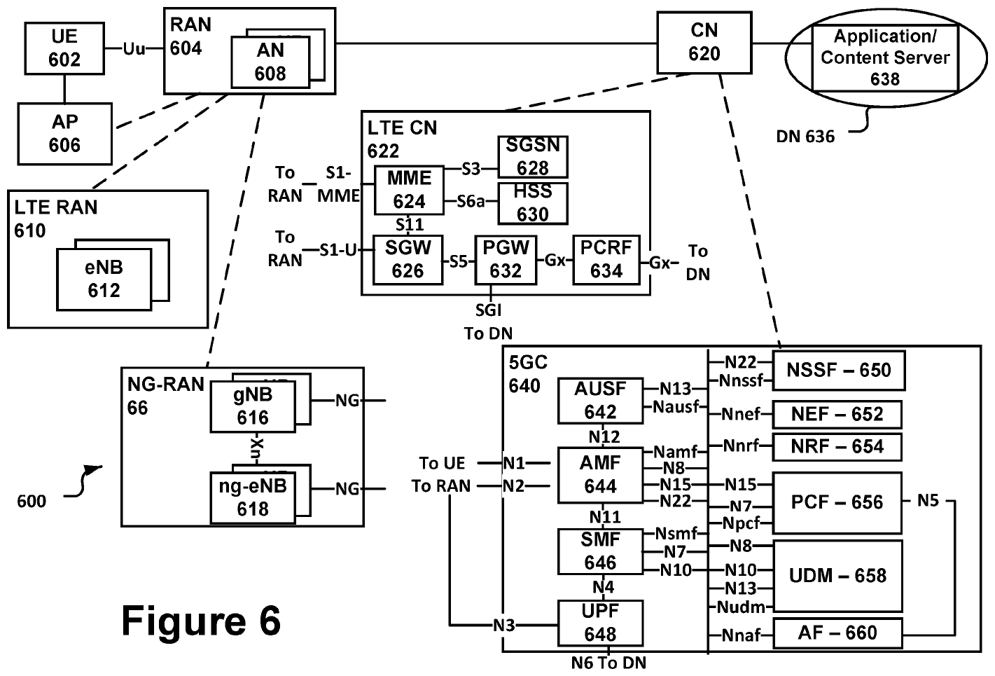

FIGS. 6-8 illustrate various systems, devices, and components that may implement aspects of disclosed embodiments.

FIG. 6 illustrates a network 600 in accordance with various embodiments. The network 600 may operate in a manner consistent with 3GPP technical specifications for LTE or 5G/NR systems. However, the example embodiments are not limited in this regard and the described embodiments may apply to other networks that benefit from the principles described herein, such as future 3GPP systems, or the like.

The network 600 may include a UE 602, which may include any mobile or non-mobile computing device designed to communicate with a RAN 604 via an over-the-air connection. The UE 602 may be, but is not limited to, a smartphone, tablet computer, wearable computer device, desktop computer, laptop computer, in-vehicle infotainment, in-car entertainment device, instrument cluster, head-up display device, onboard diagnostic device, dashtop mobile equipment, mobile data terminal, electronic engine management system, electronic/engine control unit, electronic/engine control module, embedded system, sensor, microcontroller, control module, engine management system, networked appliance, machine-type communication device, M2M or D2D device, IoT device, etc.

In some embodiments, the network 600 may include a plurality of UEs coupled directly with one another via a sidelink interface. The UEs may be M2M/D2D devices that communicate using physical sidelink channels such as, but not limited to, PSBCH, PSDCH, PSSCH, PSCCH, PSFCH, etc.

In some embodiments, the UE 602 may additionally communicate with an AP 606 via an over-the-air connection. The AP 606 may manage a WLAN connection, which may serve to offload some/all network traffic from the RAN 604. The connection between the UE 602 and the AP 606 may be consistent with any IEEE 802.11 protocol, wherein the AP 606 could be a wireless fidelity (Wi-Fi®) router. In some embodiments, the UE 602, RAN 604, and AP 606 may utilize cellular-WLAN aggregation (for example, LWA/LWIP). Cellular-WLAN aggregation may involve the UE 602 being configured by the RAN 604 to utilize both cellular radio resources and WLAN resources.

The RAN 604 may include one or more access nodes, for example, AN 608. AN 608 may terminate air-interface protocols for the UE 602 by providing access stratum protocols including RRC, PDCP, RLC, MAC, and LI protocols. In this manner, the AN 608 may enable data/voice connectivity between CN 620 and the UE 602. In some embodiments, the AN 608 may be implemented in a discrete device or as one or more software entities running on server computers as part of, for example, a virtual network, which may be referred to as a CRAN or virtual baseband unit pool. The AN 608 be referred to as a BS, gNB, RAN node, eNB, ng-eNB, NodeB, RSU, TRxP, TRP, etc. The AN 608 may be a macrocell base station or a low power base station for providing femtocells, picocells or other like cells having smaller coverage areas, smaller user capacity, or higher bandwidth compared to macrocells.

In embodiments in which the RAN 604 includes a plurality of ANs, they may be coupled with one another via an X2 interface (if the RAN 604 is an LTE RAN) or an Xn interface (if the RAN 604 is a 5G RAN). The X2/Xn interfaces, which may be separated into control/user plane interfaces in some embodiments, may allow the ANs to communicate information related to handovers, data/context transfers, mobility, load management, interference coordination, etc.

The ANs of the RAN 604 may each manage one or more cells, cell groups, component carriers, etc. to provide the UE 602 with an air interface for network access. The UE 602 may be simultaneously connected with a plurality of cells provided by the same or different ANs of the RAN 604. For example, the UE 602 and RAN 604 may use carrier aggregation to allow the UE 602 to connect with a plurality of component carriers, each corresponding to a Pcell or Scell. In dual connectivity scenarios, a first AN may be a master node that provides an MCG and a second AN may be secondary node that provides an SCG. The first/second ANs may be any combination of eNB, gNB, ng-eNB, etc.

The RAN 604 may provide the air interface over a licensed spectrum or an unlicensed spectrum. To operate in the unlicensed spectrum, the nodes may use LAA, cLAA, and/or feLAA mechanisms based on CA technology with PCells/Scells. Prior to accessing the unlicensed spectrum, the nodes may perform medium/carrier-sensing operations based on, for example, a listen-before-talk (LBT) protocol.

In V2X scenarios the UE 602 or AN 608 may be or act as a RSU, which may refer to any transportation infrastructure entity used for V2X communications. An RSU may be implemented in or by a suitable AN or a stationary (or relatively stationary) UE. An RSU implemented in or by: a UE may be referred to as a “UE-type RSU”; an eNB may be referred to as an “eNB-type RSU”; a gNB may be referred to as a “gNB-type RSU”; and the like. In one example, an RSU is a computing device coupled with radio frequency circuitry located on a roadside that provides connectivity support to passing vehicle UEs. The RSU may also include internal data storage circuitry to store intersection map geometry, traffic statistics, media, as well as applications/software to sense and control ongoing vehicular and pedestrian traffic. The RSU may provide very low latency communications required for high speed events, such as crash avoidance, traffic warnings, and the like. Additionally or alternatively, the RSU may provide other cellular/WLAN communications services. The components of the RSU may be packaged in a weatherproof enclosure suitable for outdoor installation, and may include a network interface controller to provide a wired connection (e.g., Ethernet) to a traffic signal controller or a backhaul network.

In some embodiments, the RAN 604 may be an LTE RAN 610 with eNBs, for example, eNB 612. The LTE RAN 610 may provide an LTE air interface with the following characteristics: SCS of 15 kHz; CP-OFDM waveform for DL and SC-FDMA waveform for UL; turbo codes for data and TBCC for control; etc. The LTE air interface may rely on CSI-RS for CSI acquisition and beam management; PDSCH/PDCCH DMRS for PDSCH/PDCCH demodulation; and CRS for cell search and initial acquisition, channel quality measurements, and channel estimation for coherent demodulation/detection at the UE. The LTE air interface may operating on sub-6 GHz bands.

In some embodiments, the RAN 604 may be an NG-RAN 614 with gNBs, for example, gNB 616, or ng-eNBs, for example, ng-eNB 618. The gNB 616 may connect with 5G-enabled UEs using a 5G NR interface. The gNB 616 may connect with a 5G core through an NG interface, which may include an N2 interface or an N3 interface. The ng-eNB 618 may also connect with the 5G core through an NG interface, but may connect with a UE via an LTE air interface. The gNB 616 and the ng-eNB 618 may connect with each other over an Xn interface.

In some embodiments, the NG interface may be split into two parts, an NG user plane (NG-U) interface, which carries traffic data between the nodes of the NG-RAN 614 and a UPF 648 (e.g., N3 interface), and an NG control plane (NG-C) interface, which is a signaling interface between the nodes of the NG-RAN 614 and an AMF 644 (e.g., N2 interface).

The NG-RAN 614 may provide a 5G-NR air interface with the following characteristics: variable SCS; CP-OFDM for DL, CP-OFDM and DFT-s-OFDM for UL; polar, repetition, simplex, and Reed-Muller codes for control and LDPC for data. The 5G-NR air interface may rely on CSI-RS, PDSCH/PDCCH DMRS similar to the LTE air interface. The 5G-NR air interface may not use a CRS, but may use PBCH DMRS for PBCH demodulation; PTRS for phase tracking for PDSCH; and tracking reference signal for time tracking. The 5G-NR air interface may operating on FR1 bands that include sub-6 GHz bands or FR2 bands that include bands from 24.25 GHz to 52.6 GHz. The 5G-NR air interface may include an SSB that is an area of a downlink resource grid that includes PSS/SSS/PBCH.

In some embodiments, the 5G-NR air interface may utilize BWPs for various purposes. For example, BWP can be used for dynamic adaptation of the SCS. For example, the UE 602 can be configured with multiple BWPs where each BWP configuration has a different SCS. When a BWP change is indicated to the UE 602, the SCS of the transmission is changed as well. Another use case example of BWP is related to power saving. In particular, multiple BWPs can be configured for the UE 602 with different amount of frequency resources (for example, PRBs) to support data transmission under different traffic loading scenarios. A BWP containing a smaller number of PRBs can be used for data transmission with small traffic load while allowing power saving at the UE 602 and in some cases at the gNB 616. A BWP containing a larger number of PRBs can be used for scenarios with higher traffic load.

The RAN 604 is communicatively coupled to CN 620 that includes network elements to provide various functions to support data and telecommunications services to customers/subscribers (for example, users of UE 602). The components of the CN 620 may be implemented in one physical node or separate physical nodes. In some embodiments, NFV may be utilized to virtualize any or all of the functions provided by the network elements of the CN 620 onto physical compute/storage resources in servers, switches, etc. A logical instantiation of the CN 620 may be referred to as a network slice, and a logical instantiation of a portion of the CN 620 may be referred to as a network sub-slice.

In some embodiments, the CN 620 may be an LTE CN 622, which may also be referred to as an EPC. The LTE CN 622 may include MME 624, SGW 626, SGSN 628, HSS 630, PGW 632, and PCRF 634 coupled with one another over interfaces (or “reference points”) as shown. Functions of the elements of the LTE CN 622 may be briefly introduced as follows.

The MME 624 may implement mobility management functions to track a current location of the UE 602 to facilitate paging, bearer activation/deactivation, handovers, gateway selection, authentication, etc.

The SGW 626 may terminate an SI interface toward the RAN and route data packets between the RAN and the LTE CN 622. The SGW 626 may be a local mobility anchor point for inter-RAN node handovers and also may provide an anchor for inter-3GPP mobility. Other responsibilities may include lawful intercept, charging, and some policy enforcement.

The SGSN 628 may track a location of the UE 602 and perform security functions and access control. In addition, the SGSN 628 may perform inter-EPC node signaling for mobility between different RAT networks; PDN and S-GW selection as specified by MME 624; MME selection for handovers; etc. The S3 reference point between the MME 624 and the SGSN 628 may enable user and bearer information exchange for inter-3GPP access network mobility in idle/active states.

The HSS 630 may include a database for network users, including subscription-related information to support the network entities' handling of communication sessions. The HSS 630 can provide support for routing/roaming, authentication, authorization, naming/addressing resolution, location dependencies, etc. An S6a reference point between the HSS 630 and the MME 624 may enable transfer of subscription and authentication data for authenticating/authorizing user access to the LTE CN 620.

The PGW 632 may terminate an SGi interface toward a data network (DN) 636 that may include an application/content server 638. The PGW 632 may route data packets between the LTE CN 622 and the data network 636. The PGW 632 may be coupled with the SGW 626 by an S5 reference point to facilitate user plane tunneling and tunnel management. The PGW 632 may further include a node for policy enforcement and charging data collection (for example, PCEF). Additionally, the SGi reference point between the PGW 632 and the data network 6 36 may be an operator external public, a private PDN, or an intra-operator packet data network, for example, for provision of IMS services. The PGW 632 may be coupled with a PCRF 634 via a Gx reference point.

The PCRF 634 is the policy and charging control element of the LTE CN 622. The PCRF 634 may be communicatively coupled to the app/content server 638 to determine appropriate QoS and charging parameters for service flows. The PCRF 632 may provision associated rules into a PCEF (via Gx reference point) with appropriate TFT and QCI.

In some embodiments, the CN 620 may be a 5GC 640. The 5GC 640 may include an AUSF 642, AMF 644, SMF 646, UPF 648, NSSF 650, NEF 652, NRF 654, PCF 656, UDM 658, and AF 660 coupled with one another over interfaces (or “reference points”) as shown. Functions of the elements of the 5GC 640 may be briefly introduced as follows.

The AUSF 642 may store data for authentication of UE 602 and handle authentication-related functionality. The AUSF 642 may facilitate a common authentication framework for various access types. In addition to communicating with other elements of the 5GC 640 over reference points as shown, the AUSF 642 may exhibit an Nausf service-based interface.

The AMF 644 may allow other functions of the 5GC 640 to communicate with the UE 602 and the RAN 604 and to subscribe to notifications about mobility events with respect to the UE 602. The AMF 644 may be responsible for registration management (for example, for registering UE 602), connection management, reachability management, mobility management, lawful interception of AMF-related events, and access authentication and authorization. The AMF 644 may provide transport for SM messages between the UE 602 and the SMF 646, and act as a transparent proxy for routing SM messages. AMF 644 may also provide transport for SMS messages between UE 602 and an SMSF. AMF 644 may interact with the AUSF 642 and the UE 602 to perform various security anchor and context management functions. Furthermore, AMF 644 may be a termination point of a RAN CP interface, which may include or be an N2 reference point between the RAN 604 and the AMF 644; and the AMF 644 may be a termination point of NAS (N1) signaling, and perform NAS ciphering and integrity protection. AMF 644 may also support NAS signaling with the UE 602 over an N3 IWF interface.

The SMF 646 may be responsible for SM (for example, session establishment, tunnel management between UPF 648 and AN 608); UE IP address allocation and management (including optional authorization); selection and control of UP function; configuring traffic steering at UPF 648 to route traffic to proper destination: termination of interfaces toward policy control functions; controlling part of policy enforcement, charging, and QoS; lawful intercept (for SM events and interface to LI system); termination of SM parts of NAS messages; downlink data notification: initiating AN specific SM information, sent via AMF 644 over N2 to AN 608; and determining SSC mode of a session. SM may refer to management of a PDU session, and a PDU session or “session” may refer to a PDU connectivity service that provides or enables the exchange of PDUs between the UE 602 and the data network 636.

The UPF 648 may act as an anchor point for intra-RAT and inter-RAT mobility, an external PDU session point of interconnect to data network 636, and a branching point to support multi-homed PDU session. The UPF 648 may also perform packet routing and forwarding, perform packet inspection, enforce the user plane part of policy rules, lawfully intercept packets (UP collection), perform traffic usage reporting, perform QoS handling for a user plane (e.g., packet filtering, gating, UL/DL rate enforcement), perform uplink traffic verification (e.g., SDF-to-QoS flow mapping), transport level packet marking in the uplink and downlink, and perform downlink packet buffering and downlink data notification triggering. UPF 648 may include an uplink classifier to support routing traffic flows to a data network.

The NSSF 650 may select a set of network slice instances serving the UE 602. The NSSF 650 may also determine allowed NSSAI and the mapping to the subscribed S-NSSAIs, if needed. The NSSF 650 may also determine the AMF set to be used to serve the UE 602, or a list of candidate AMFs based on a suitable configuration and possibly by querying the NRF 654. The selection of a set of network slice instances for the UE 602 may be triggered by the AMF 644 with which the UE 602 is registered by interacting with the NSSF 650, which may lead to a change of AMF. The NSSF 650 may interact with the AMF 644 via an N22 reference point; and may communicate with another NSSF in a visited network via an N31 reference point (not shown). Additionally, the NSSF 650 may exhibit an Nnssf service-based interface.

The NEF 652 may securely expose services and capabilities provided by 3GPP network functions for third party, internal exposure/re-exposure, AFs (e.g., AF 660), edge computing or fog computing systems, etc. In such embodiments, the NEF 652 may authenticate, authorize, or throttle the AFs. NEF 652 may also translate information exchanged with the AF 660 and information exchanged with internal network functions. For example, the NEF 652 may translate between an AF-Service-Identifier and an internal 5GC information. NEF 652 may also receive information from other NFs based on exposed capabilities of other NFs. This information may be stored at the NEF 652 as structured data, or at a data storage NF using standardized interfaces. The stored information can then be re-exposed by the NEF 652 to other NFs and AFs, or used for other purposes such as analytics. Additionally, the NEF 652 may exhibit an Nnef service-based interface.

The NRF 654 may support service discovery functions, receive NF discovery requests from NF instances, and provide the information of the discovered NF instances to the NF instances. NRF 654 also maintains information of available NF instances and their supported services. As used herein, the terms “instantiate,” “instantiation,” and the like may refer to the creation of an instance, and an “instance” may refer to a concrete occurrence of an object, which may occur, for example, during execution of program code. Additionally, the NRF 654 may exhibit the Nnrf service-based interface.

The PCF 656 may provide policy rules to control plane functions to enforce them, and may also support unified policy framework to govern network behavior. The PCF 656 may also implement a front end to access subscription information relevant for policy decisions in a UDR of the UDM 658. In addition to communicating with functions over reference points as shown, the PCF 656 exhibit an Npcf service-based interface.

The UDM 658 may handle subscription-related information to support the network entities' handling of communication sessions, and may store subscription data of UE 602. For example, subscription data may be communicated via an N8 reference point between the UDM 658 and the AMF 644. The UDM 658 may include two parts, an application front end and a UDR. The UDR may store subscription data and policy data for the UDM 658 and the PCF 656, and/or structured data for exposure and application data (including PFDs for application detection, application request information for multiple UEs 602) for the NEF 652. The Nudr service-based interface may be exhibited by the UDR 221 to allow the UDM 658, PCF 656, and NEF 652 to access a particular set of the stored data, as well as to read, update (e.g., add, modify), delete, and subscribe to notification of relevant data changes in the UDR. The UDM may include a UDM-FE, which is in charge of processing credentials, location management, subscription management and so on. Several different front ends may serve the same user in different transactions. The UDM-FE accesses subscription information stored in the UDR and performs authentication credential processing, user identification handling, access authorization, registration/mobility management, and subscription management. In addition to communicating with other NFs over reference points as shown, the UDM 658 may exhibit the Nudm service-based interface.

The AF 660 may provide application influence on traffic routing, provide access to NEF, and interact with the policy framework for policy control.

In some embodiments, the 5GC 640 may enable edge computing by selecting operator/3rd party services to be geographically close to a point that the UE 602 is attached to the network. This may reduce latency and load on the network. To provide edge-computing implementations, the 5GC 640 may select a UPF 648 close to the UE 602 and execute traffic steering from the UPF 648 to data network 636 via the N6 interface. This may be based on the UE subscription data, UE location, and information provided by the AF 660. In this way, the AF 660 may influence UPF (re) selection and traffic routing. Based on operator deployment, when AF 660 is considered to be a trusted entity, the network operator may permit AF 660 to interact directly with relevant NFs. Additionally, the AF 660 may exhibit an Naf service-based interface.

The data network 636 may represent various network operator services, Internet access, or third party services that may be provided by one or more servers including, for example, application/content server 638.

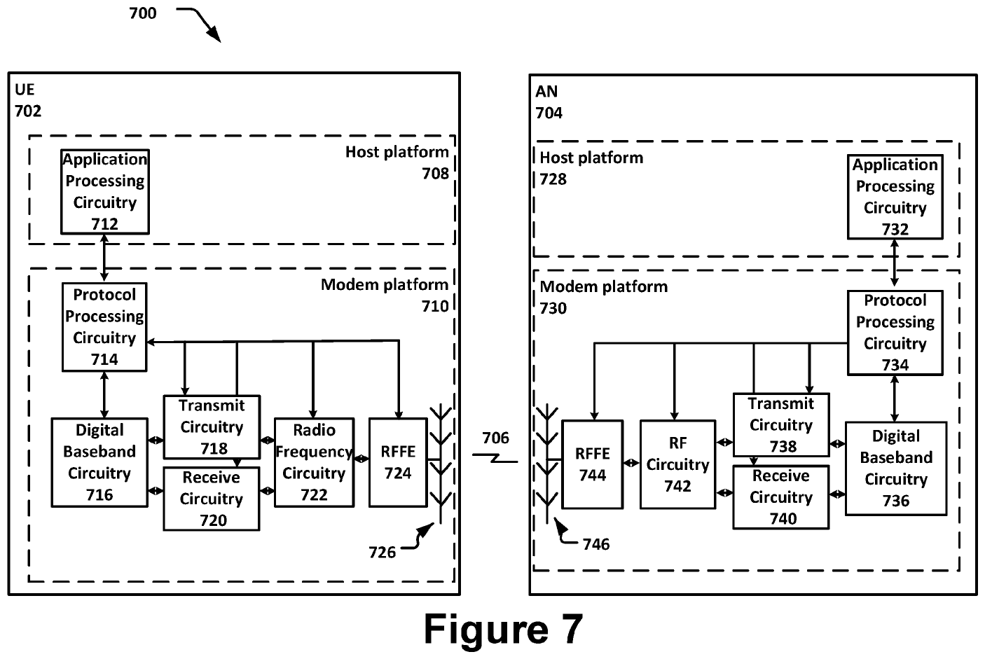

FIG. 7 schematically illustrates a wireless network 700 in accordance with various embodiments. The wireless network 700 may include a UE 702 in wireless communication with an AN 704. The UE 702 and AN 704 may be similar to, and substantially interchangeable with, like-named components described elsewhere herein.

The UE 702 may be communicatively coupled with the AN 704 via connection 706. The connection 706 is illustrated as an air interface to enable communicative coupling, and can be consistent with cellular communications protocols such as an LTE protocol or a 5G NR protocol operating at mmWave or sub-6 GHZ frequencies.

The UE 702 may include a host platform 708 coupled with a modem platform 710. The host platform 708 may include application processing circuitry 712, which may be coupled with protocol processing circuitry 714 of the modem platform 710. The application processing circuitry 712 may run various applications for the UE 702 that source/sink application data. The application processing circuitry 712 may further implement one or more layer operations to transmit/receive application data to/from a data network. These layer operations may include transport (for example UDP) and Internet (for example, IP) operations

The protocol processing circuitry 714 may implement one or more of layer operations to facilitate transmission or reception of data over the connection 706. The layer operations implemented by the protocol processing circuitry 714 may include, for example, MAC, RLC, PDCP, RRC and NAS operations.

The modem platform 710 may further include digital baseband circuitry 716 that may implement one or more layer operations that are “below” layer operations performed by the protocol processing circuitry 714 in a network protocol stack. These operations may include, for example, PHY operations including one or more of HARQ-ACK functions, scrambling/descrambling, encoding/decoding, layer mapping/de-mapping, modulation symbol mapping, received symbol/bit metric determination, multi-antenna port precoding/decoding, which may include one or more of space-time, space-frequency or spatial coding, reference signal generation/detection, preamble sequence generation and/or decoding, synchronization sequence generation/detection, control channel signal blind decoding, and other related functions.

The modem platform 710 may further include transmit circuitry 718, receive circuitry 720, RF circuitry 722, and RF front end (RFFE) 724, which may include or connect to one or more antenna panels 726. Briefly, the transmit circuitry 718 may include a digital-to-analog converter, mixer, intermediate frequency (IF) components, etc.; the receive circuitry 720 may include an analog-to-digital converter, mixer, IF components, etc.; the RF circuitry 722 may include a low-noise amplifier, a power amplifier, power tracking components, etc.; RFFE 724 may include filters (for example, surface/bulk acoustic wave filters), switches, antenna tuners, beamforming components (for example, phase-array antenna components), etc. The selection and arrangement of the components of the transmit circuitry 718, receive circuitry 720, RF circuitry 722, RFFE 724, and antenna panels 726 (referred generically as “transmit/receive components”) may be specific to details of a specific implementation such as, for example, whether communication is TDM or FDM, in mmWave or sub-6 gHz frequencies, etc. In some embodiments, the transmit/receive components may be arranged in multiple parallel transmit/receive chains, may be disposed in the same or different chips/modules, etc.

In some embodiments, the protocol processing circuitry 714 may include one or more instances of control circuitry (not shown) to provide control functions for the transmit/receive components.

A UE reception may be established by and via the antenna panels 726, RFFE 724, RF circuitry 722, receive circuitry 720, digital baseband circuitry 716, and protocol processing circuitry 714. In some embodiments, the antenna panels 726 may receive a transmission from the AN 704 by receive-beamforming signals received by a plurality of antennas/antenna elements of the one or more antenna panels 726.

A UE transmission may be established by and via the protocol processing circuitry 714, digital baseband circuitry 716, transmit circuitry 718, RF circuitry 722, RFFE 724, and antenna panels 726. In some embodiments, the transmit components of the UE 704 may apply a spatial filter to the data to be transmitted to form a transmit beam emitted by the antenna elements of the antenna panels 726.

Similar to the UE 702, the AN 704 may include a host platform 728 coupled with a modem platform 730. The host platform 728 may include application processing circuitry 732 coupled with protocol processing circuitry 734 of the modem platform 730. The modem platform may further include digital baseband circuitry 736, transmit circuitry 738, receive circuitry 740, RF circuitry 742, RFFE circuitry 744, and antenna panels 746. The components of the AN 704 may be similar to and substantially interchangeable with like-named components of the UE 702. In addition to performing data transmission/reception as described above, the components of the AN 708 may perform various logical functions that include, for example, RNC functions such as radio bearer management, uplink and downlink dynamic radio resource management, and data packet scheduling.

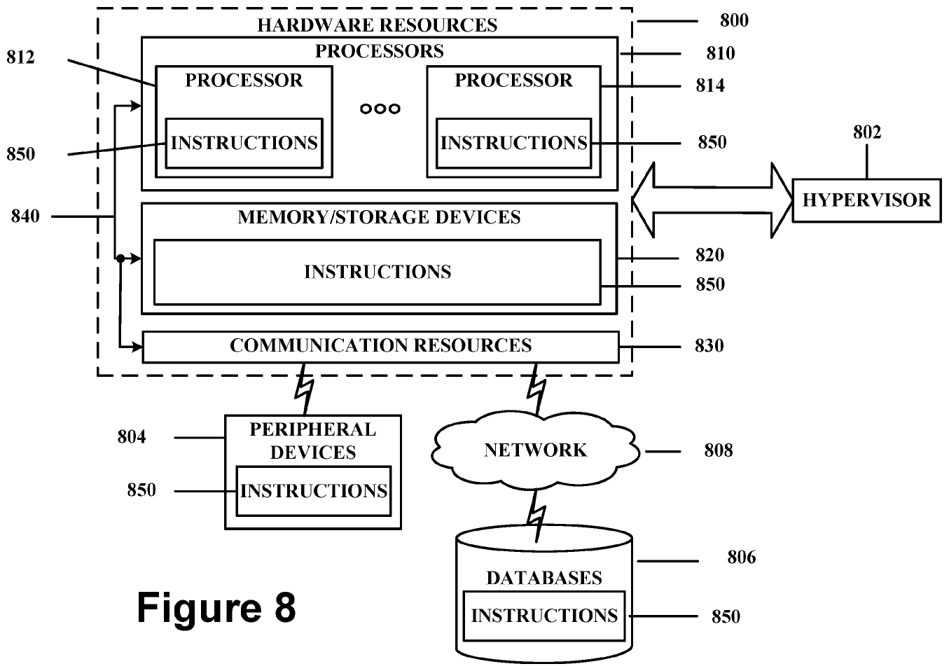

FIG. 8 is a block diagram illustrating components, according to some example embodiments, able to read instructions from a machine-readable or computer-readable medium (e.g., a non-transitory machine-readable storage medium) and perform any one or more of the methodologies discussed herein. Specifically, FIG. 8 shows a diagrammatic representation of hardware resources 800 including one or more processors (or processor cores) 810, one or more memory/storage devices 820, and one or more communication resources 830, each of which may be communicatively coupled via a bus 840 or other interface circuitry. For embodiments where node virtualization (e.g., NFV) is utilized, a hypervisor 802 may be executed to provide an execution environment for one or more network slices/sub-slices to utilize the hardware resources 800.

The processors 810 may include, for example, a processor 812 and a processor 814. The processors 810 may be, for example, a central processing unit (CPU), a reduced instruction set computing (RISC) processor, a complex instruction set computing (CISC) processor, a graphics processing unit (GPU), a DSP such as a baseband processor, an ASIC, an FPGA, a radio-frequency integrated circuit (RFIC), another processor (including those discussed herein), or any suitable combination thereof.

The memory/storage devices 820 may include main memory, disk storage, or any suitable combination thereof. The memory/storage devices 820 may include, but are not limited to, any type of volatile, non-volatile, or semi-volatile memory such as dynamic random access memory (DRAM), static random access memory (SRAM), erasable programmable read-only memory (EPROM), electrically erasable programmable read-only memory (EEPROM), Flash memory, solid-state storage, etc.

The communication resources 830 may include interconnection or network interface controllers, components, or other suitable devices to communicate with one or more peripheral devices 804 or one or more databases 806 or other network elements via a network 808. For example, the communication resources 830 may include wired communication components (e.g., for coupling via USB, Ethernet, etc.), cellular communication components, NFC components, Bluetooth® (or Bluetooth® Low Energy) components, Wi-Fi® components, and other communication components.

Instructions 850 may comprise software, a program, an application, an applet, an app, or other executable code for causing at least any of the processors 810 to perform any one or more of the methodologies discussed herein. The instructions 850 may reside, completely or partially, within at least one of the processors 810 (e.g., within the processor's cache memory), the memory/storage devices 820, or any suitable combination thereof. Furthermore, any portion of the instructions 850 may be transferred to the hardware resources 800 from any combination of the peripheral devices 804 or the databases 806. Accordingly, the memory of processors 810, the memory/storage devices 820, the peripheral devices 804, and the databases 806 are examples of computer-readable and machine-readable media.

### EXAMPLE PROCEDURES

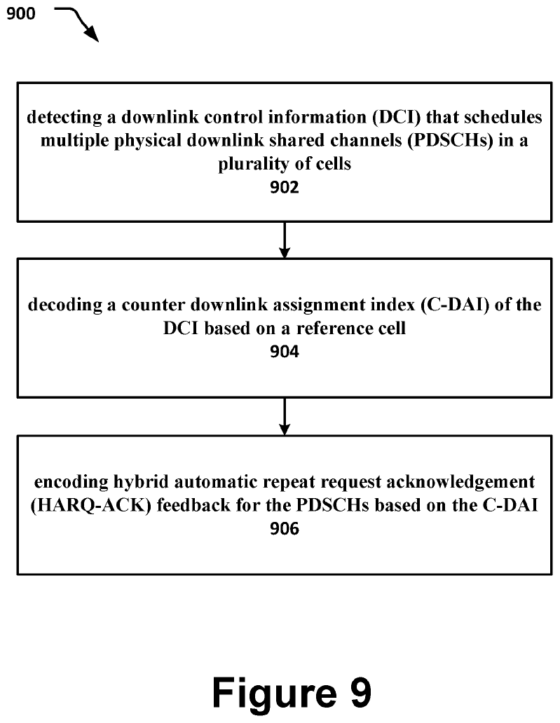

In some embodiments, the electronic device(s), network(s), system(s), chip(s) or component(s), or portions or implementations thereof, of FIGS. 6-8, or some other figure herein, may be configured to perform one or more processes, techniques, or methods as described herein, or portions thereof. One such process 900 is depicted in FIG. 9. In some embodiments, the process 900 may be performed by a UE or a portion thereof. At 902, the process 900 may include detecting a downlink control information (DCI) that schedules multiple physical downlink shared channels (PDSCHs) in a plurality of cells. At 904, the process 900 may further include decoding a counter downlink assignment index (C-DAI) of the DCI based on a reference cell. At 906, the process 900 may further include encoding hybrid automatic repeat request acknowledgement (HARQ-ACK) feedback for the PDSCHs based on the C-DAI.

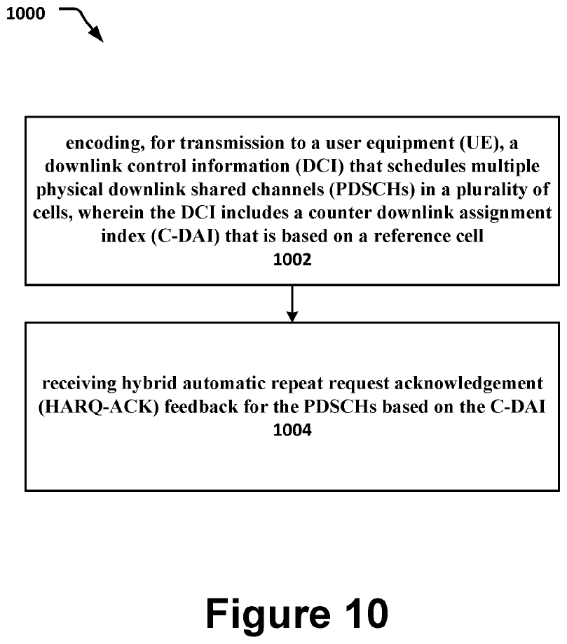

FIG. 10 illustrates another example process 1000 in accordance with various embodiments. In some embodiments, the process 1000 may be performed by a gNB or a portion thereof. At 1002, the process 1000 may include encoding, for transmission to a user equipment (UE), a downlink control information (DCI) that schedules multiple physical downlink shared channels (PDSCHs) in a plurality of cells, wherein the DCI includes a counter downlink assignment index (C-DAI) that is based on a reference cell. At 1004, the process 1000 may further include receiving hybrid automatic repeat request acknowledgement (HARQ-ACK) feedback for the PDSCHs based on the C-DAI.

For one or more embodiments, at least one of the components set forth in one or more of the preceding figures may be configured to perform one or more operations, techniques, processes, and/or methods as set forth in the example section below. For example, the baseband circuitry as described above in connection with one or more of the preceding figures may be configured to operate in accordance with one or more of the examples set forth below. For another example, circuitry associated with a UE, base station, network element, etc. as described above in connection with one or more of the preceding figures may be configured to operate in accordance with one or more of the examples set forth below in the example section.

### EXAMPLES

Example A1 may include one or more non-transitory computer-readable media (NTCRM) having instructions, stored thereon, that when executed by one or more processors of a user equipment (UE) configure the UE to: detect a downlink control information (DCI) that schedules multiple physical downlink shared channels (PDSCHs) in a plurality of cells; decode a counter downlink assignment index (C-DAI) of the DCI based on a reference cell; and encode hybrid automatic repeat request acknowledgement (HARQ-ACK) feedback for the PDSCHs based on the C-DAI.

Example A2 may include the one or more NTCRM of example A1, wherein the HARQ-ACK feedback is encoded based on a second sub-codebook that is different than a first sub-codebook used for single-cell PDSCH scheduling.

Example A3 may include the one or more NTCRM of example A2, wherein the C-DAI is to count a number of physical downlink control channels (PDCCHs) with the second sub-codebook.

Example A4 may include the one or more NTCRM of any one of examples A2-A3, wherein the instructions, when executed, are further to configure the UE to determine a number of HARQ-ACK bits for the C-DAI in the HARQ-ACK feedback based on a maximum number of HARQ-ACK bits for PDSCHs which can be scheduled by a physical downlink control channel (PDCCH) in the second sub-codebook.

Example A5 may include the one or more NTCRM of any one of examples A2-A4, wherein HARQ-ACK information bits for the multiple PDSCHs in the HARQ-ACK feedback in the second sub-codebook are ordered based on respective serving cell indices of the plurality of cells.

Example A6 may include the one or more NTCRM of example A5, wherein the HARQ-ACK information bits are first mapped to bit locations, and wherein the instructions, when executed, are further to configure the UE to add one or more padding bits after the HARQ-ACK information bits if an expected number of bits per physical downlink control channel (PDCCH) is greater than the number of HARQ-ACK information bits for the multiple PDSCHs.

Example A7 may include the one or more NTCRM of example A1, wherein the reference cell is selected from the plurality of cells based on a cell index.

Example A8 may include the one or more NTCRM of example A7, wherein the reference cell is selected as the cell with the lowest cell index among the plurality of cells.

Example A9 may include the one or more NTCRM of example A1, wherein the reference cell is: a serving cell for a reference PDSCH of the multiple PDSCHs; selected according to a starting position or ending position of the reference cell among the multiple cells; or configured for the UE by a next generation Node B (gNB).

Example A10 may include one or more non-transitory computer-readable media (NTCRM) having instructions, stored thereon, that when executed by one or more processors of a next generation Node B (gNB) configure the gNB to: encode, for transmission to a user equipment (UE), a downlink control information (DCI) that schedules multiple physical downlink shared channels (PDSCHs) in a plurality of cells, wherein the DCI includes a counter downlink assignment index (C-DAI) that is based on a reference cell; and receive hybrid automatic repeat request acknowledgement (HARQ-ACK) feedback for the PDSCHs based on the C-DAI.

Example A11 may include the one or more NTCRM of example A10, wherein the HARQ-ACK feedback is encoded based on a second sub-codebook that is different than a first sub-codebook used for single-cell PDSCH scheduling.

Example A12 may include the one or more NTCRM of example A11, wherein the C-DAI is to count a number of physical downlink control channels (PDCCHs) with the second sub-codebook.

Example A13 may include the one or more NTCRM of any one of examples A11-A12, wherein a number of HARQ-ACK bits for the C-DAI in the HARQ-ACK feedback is based on a maximum number of HARQ-ACK bits for PDSCHs which can be scheduled by a physical downlink control channel (PDCCH) in the second sub-codebook.

Example A14 may include the one or more NTCRM of any one of examples A11-A13, wherein HARQ-ACK information bits for the multiple PDSCHs in the HARQ-ACK feedback in the second sub-codebook are ordered based on respective serving cell indices of the plurality of cells.

Example A15 may include the one or more NTCRM of example A14, wherein the HARQ-ACK information bits are first mapped to bit locations, and wherein the wherein the HARQ-ACK feedback further includes one or more padding bits after the HARQ-ACK information bits if an expected number of bits per physical downlink control channel (PDCCH) is greater than the number of HARQ-ACK information bits for the multiple PDSCHs.

Example A16 may include the one or more NTCRM of example A10, wherein the reference cell is selected from the plurality of cells based on a cell index.

Example A17 may include the one or more NTCRM of example A16, wherein the reference cell is selected as the cell with the lowest cell index among the plurality of cells.

Example A18 may include the one or more NTCRM of example A10, wherein the reference cell is: a serving cell for a reference PDSCH of the multiple PDSCHs; selected according to a starting position or ending position of the reference cell among the multiple cells; or configured for the UE by the gNB.

Example A19 may include the one or more NTCRM of claim 10, wherein the instructions when executed, are further to configure the gNB to: identify a restriction that the UE should not be configured with codeblock group (CBG)-based transmission on a cell within a PDSCH group that is configured for multi-cell scheduling; and schedule one or more additional PDSCHs based on the restriction.

Example A20 may include the one or more NTCRM of claim 10, wherein the instructions when executed, are further to configure the gNB to: identify a restriction that the UE should not be configured with multi-PDSCH scheduling on a cell within a PDSCH group that is configured for multi-cell scheduling; and schedule one or more additional PDSCHs based on the restriction.

Example B1 may include a method of wireless communication, the method comprising: UE receives the configuration of a search space set of a DCI format for multi-cell scheduling; and UE detects a DCI format for multi-cell scheduling and receives one or multiple PDSCH(s) or transmits one or multiple PUSCH(s) accordingly following the Downlink (DL) assignment or Uplink (UL) grant in the detected DCI format.

Example B2 may include the method of example B1 or some other example herein, wherein multiple PDSCHs scheduled by a DCI for multi-cell scheduling are associated with different TBs respectively.

Example B3 may include the method of example B2 or some other example herein, wherein for type-2 codebook, DAI is counted according to the serving cell index of a reference PDSCH of multiple PDSCHs scheduled by a DCI for multi-cell scheduling.

Example B4 may include the method of example B2 or some other example herein, wherein for type-2 codebook, HARQ-ACK for PDSCHs scheduled by a DCI for multi-cell scheduling and HARQ-ACK for a PDSCH scheduled by a DCI for single-cell scheduling is in different sub-codebook.

Example B5 may include the method of example B2 or some other example herein, for type-2 codebook, HARQ-ACK for PDSCHs scheduled by a DCI for multi-cell scheduling and HARQ-ACK for a PDSCH scheduled by a DCI for single-cell scheduling is in the same sub-codebook.

Example B6 may include the method of example B4 or example B5 or some other example herein, for type-2 codebook, DAI counts PDCCHs within the same sub-codebook.

Example B7 may include the method of example B5 or some other example herein, wherein for type-2 codebook, DAI counts PDSCHs within the same sub-codebook.

Example B8 may include a method of a user equipment (UE), the method comprising: receiving a configuration of a search space set for a downlink control information (DCI) format for multi-cell scheduling; detecting a DCI with the DCI format based on the configuration, wherein the DCI includes a downlink (DL) assignment or an uplink (UL) grant; and receiving multiple physical downlink shared channels (PDSCHs) in accordance with the DL assignment or transmitting multiple physical uplink shared channels (PUSCHs) in accordance with the UL grant.

Example B9 may include the method of example B8 or some other example herein, wherein the multiple PDSCHs are associated with different transport blocks (TBs).

Example B10 may include the method of example B9 or some other example herein, wherein the DAI is counted according to a serving cell index of a reference PDSCH of the multiple PDSCHs.

Example B11 may include the method of example B9 or some other example herein, wherein hybrid automatic repeat request (HARQ)-acknowledgement (ACK) for the multiple PDSCHs scheduled by the DCI use a different sub-codebook from HARQ-ACK for a single PDSCH scheduled for single-cell scheduling.

Example B12 may include the method of example B9 or some other example herein, wherein hybrid automatic repeat request (HARQ)-acknowledgement (ACK) for the multiple PDSCHs scheduled by the DCI use a same sub-codebook as HARQ-ACK for a single PDSCH scheduled for single-cell scheduling.

Example B13 may include the method of example B11, example B12, or some other example herein, wherein the DAI counts one or more PDCCHs within the same sub-codebook used for multi-cell scheduling.

Example B14 may include the method of example B12 or some other example herein, wherein the DAI counts PDSCHs within the same sub-codebook used for multi-cell scheduling.

Example B15 may include the method of any of examples B8-B14 or some other example herein, wherein the PDSCHs or PUSCHs are associated with a type-2 codebook.

Example B16 may include a method of a next generation Node B (gNB), the method comprising: configuring, for a user equipment (UE), a search space set for a downlink control information (DCI) format for multi-cell scheduling; transmitting a DCI with the DCI format to the UE based on the search space set, wherein the DCI includes a downlink (DL) assignment for multiple physical uplink shared channels (PUSCHs) or an uplink (UL) grant for multiple physical uplink shared channels (PUSCHs); and transmitting one or more of the PDSCHs in accordance with the DL assignment or receiving one or more of the PUSCHs in accordance with the UL grant.

Example B17 may include the method of example B16 or some other example herein, wherein the multiple PDSCHs are associated with different transport blocks (TBs).

Example B18 may include the method of example B17 or some other example herein, wherein the DAI is counted according to a serving cell index of a reference PDSCH of the multiple PDSCHs.

Example B19 may include the method of example B17 or some other example herein, wherein hybrid automatic repeat request (HARQ)-acknowledgement (ACK) for the multiple PDSCHs scheduled by the DCI use a different sub-codebook from HARQ-ACK for a single PDSCH scheduled for single-cell scheduling.

Example B20 may include the method of example B17 or some other example herein, wherein hybrid automatic repeat request (HARQ)-acknowledgement (ACK) for the multiple PDSCHs scheduled by the DCI use a same sub-codebook as HARQ-ACK for a single PDSCH scheduled for single-cell scheduling.

Example B21 may include the method of example B19, example B20, or some other example herein, wherein the DAI counts one or more PDCCHs within the same sub-codebook used for multi-cell scheduling.

Example B22 may include the method of example B20 or some other example herein, wherein the DAI counts PDSCHs within the same sub-codebook used for multi-cell scheduling.

Example B23 may include the method of any of examples B16-B22 or some other example herein, wherein the PDSCHs or PUSCHs are associated with a type-2 codebook.

Example Z01 may include an apparatus comprising means to perform one or more elements of a method described in or related to any of examples A1-A20, B1-B23, or any other method or process described herein.

Example Z02 may include one or more non-transitory computer-readable media comprising instructions to cause an electronic device, upon execution of the instructions by one or more processors of the electronic device, to perform one or more elements of a method described in or related to any of examples A1-A20, B1-B23, or any other method or process described herein.

Example Z03 may include an apparatus comprising logic, modules, or circuitry to perform one or more elements of a method described in or related to any of examples A1-A20, B1-B23, or any other method or process described herein.

Example Z04 may include a method, technique, or process as described in or related to any of examples A1-A20, B1-B23, or portions or parts thereof.

Example Z05 may include an apparatus comprising: one or more processors and one or more computer-readable media comprising instructions that, when executed by the one or more processors, cause the one or more processors to perform the method, techniques, or process as described in or related to any of examples A1-A20, B1-B23, or portions thereof.

Example Z06 may include a signal as described in or related to any of examples A1-A20, B1-B23, or portions or parts thereof.

Example Z07 may include a datagram, packet, frame, segment, protocol data unit (PDU), or message as described in or related to any of examples A1-A20, B1-B23, or portions or parts thereof, or otherwise described in the present disclosure.

Example Z08 may include a signal encoded with data as described in or related to any of examples A1-A20, B1-B23, or portions or parts thereof, or otherwise described in the present disclosure.

Example Z09 may include a signal encoded with a datagram, packet, frame, segment, protocol data unit (PDU), or message as described in or related to any of examples A1-A20, B1-B23, or portions or parts thereof, or otherwise described in the present disclosure.

Example Z10 may include an electromagnetic signal carrying computer-readable instructions, wherein execution of the computer-readable instructions by one or more processors is to cause the one or more processors to perform the method, techniques, or process as described in or related to any of examples A1-A20, B1-B23, or portions thereof.

Example Z11 may include a computer program comprising instructions, wherein execution of the program by a processing element is to cause the processing element to carry out the method, techniques, or process as described in or related to any of examples A1-A20, B1-B23, or portions thereof.

Example Z12 may include a signal in a wireless network as shown and described herein.

Example Z13 may include a method of communicating in a wireless network as shown and described herein.

Example Z14 may include a system for providing wireless communication as shown and described herein.

Example Z15 may include a device for providing wireless communication as shown and described herein.

Any of the above-described examples may be combined with any other example (or combination of examples), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

### Abbreviations

Unless used differently herein, terms, definitions, and abbreviations may be consistent with terms, definitions, and abbreviations defined in 3GPP TR 21.905 v16.0.0 (2019 June). For the purposes of the present document, the following abbreviations may apply to the examples and embodiments discussed herein.

| | | | | | |
|---|---|---|---|---|---|
| 3GPP | Third Generation | AOA | Angle of | BPSK | Binary Phase |
| | Partnership | | Arrival | | Shift Keying |
| | Project | AP | Application | BRAS | Broadband |
| 4G | Fourth Generation | | Protocol, | | Remote Access |
| 5G | Fifth Generation | | Antenna | | Server |
| 5GC | 5G Core network | | Port, Access | BSS | Business |
| AC | Application | | Point | | Support System |
| | Client | API | Application | BS | Base Station |
| ACR | Application | | Programming | BSR | Buffer Status |
| | Context Relocation | | Interface | | Report |
| ACK | Acknowledgement | APN | Access Point | BW | Bandwidth |
| ACID | Application Client | | Name | BWP | Bandwidth |
| | Identification | ARP | Allocation | | Part |
| AF | Application | | and Retention | C-RNTI | Cell Radio |
| | Function | | Priority | | Network |
| AM | Ackowledged | ARQ | Automatic | | Temporary |
| | Mode | | Repeat Request | | Identity |
| AMBR | Aggregate | AS | Access Stratum | CA | Carrier |
| | Maxium Bit Rate | ASP | Application | | Aggregation, |
| AMF | Access and | | Service Provider | | Certification |
| | Mobility | ASN.1 | Abstract Syntax | | Authority |
| | Management | | Notation One | CAPEX | CAPital |
| | Function | AUSF | Authentication | | EXpenditure |
| AN | Access Network | | Sever Function | CBRA | Contention |
| ANR | Automatic | AWGN | Additive White | | Based Random |
| | Neighbour Relation | | Gaussian Noise | | Access |
| CE | Coverage | BAP | Backhual | CC | Component |
| | Enhancement | | Adaptation | | Carrier, |
| CDM | Content Delivery | | Protocol | | Country Code, |
| | Network | BCH | Broadcast | | Cryptographic |
| CDMA | Code-Division | | Channel | | Checksum |
| | Multiple Access | BER | Bit Error Ratio | CCA | Clear Channel |
| CDR | Charging Data | BFD | Beam Failure | | Assessment |
| | Request | | Detection | CCE | Control |
| CDR | Charging Data | BLER | Block Error | | Channel |
| | Response | | Rate | | Element |
| CFRA | Contention Free | CO | Conditional | CCCH | Common |
| | Random Access | | Optional | | Control |
| CG | Cell Group | CoMP | Coorinated | | Channel |
| CGF | Charging Gateway | | Multi-Point | CRI | Channel-State |
| | Function | CORESET | Control | | Information |
| CHF | Charging Function | | Resource Set | | Resource |
| CI | Cell Identity | COTS | Commercial | | Indicator, |
| CID | Cell-ID (e.g., | | Off-The-Shelf | | CSI-RS |
| | positioning method) | CP | Control Plane, | | Resource |
| CIM | Common Information | | Cyclic Prefix, | | Indicator |
| | Model | | Connection | C-RNTI | Cell RNTI |
| CIR | Carrier to Interference | | Point | CS | Circuit Switched |
| | Ratio | CPD | Connection | CSCF | call session |
| CK | Cipher Key | | Point Descriptor | | control function |
| CM | Connection | CPE | Customer | CSAR | Cloud Service |
| | Management, | | Premise | | Archive |
| | Conditional | | Equipment | CSI | Channel-State |
| | Mandatory | CPICH | Common Pilot | | Information |
| CMAS | Commercial Mobile | | Channel | CSI-IM | CSI Interference |
| | Alert Service | CQI | Channel | | Measurement |
| CMD | Command | | Quality Indicator | CSI-RS | CSI Reference |
| CMS | Cloud Management | CPU | CSI processing | | Signal |
| | System | | unit, Central | CSI- | CSI reference |
| CSMA/ | CSMA with collision | | Processing Unit | RSRP | signal received |
| CA | avoidance | C/R | Command/ | | power |
| CSS | Common Search | | Response field | CSI- | CSI reference |
| | Space, Cell-specific | | bit | RSRQ | signal received |
| | Search Space | CRAN | Cloud Radio | | quality |
| CTF | Charging Trigger | | Access | CSI- | CSI signal-to- |
| | Function | | Network, Cloud | SINR | noise and |
| CTS | Clear-to-Send | | RAN | | interference |
| CW | Codeword | CRB | Common | | ratio |
| CWS | Contantion Window | | Resource Block | CSMA | Carrier Sense |
| | Size | CRC | Cyclic | | Multiple Access |
| D2D | Device-to-Device | | Redundancy | | Evolution |
| DC | Dual Connectivity, | | Check | | (GSM |
| | Direct Current | DNAI | Data Network | | Evolution) |
| DCI | Downlink Control | | Access Identifier | EAS | Edge Application |
| | Information | DRB | Data Radio | | Server |
| DF | Deployment Flavour | | Bearer | EASID | Edge Application |
| DL | Downlink | DRS | Discovery | | Server |
| DMFT | Distributed | | Reference | | Identification |
| | Management Task | | Signal | ECS | Edge |
| | Force | DRX | Discontinuous | | Configuration |
| DPDK | Data Plane | | Reception | | Server |
| | Development Kit | DSL | Domain | ECSP | Edge Computing |
| DM-RS, | Demodulation | | Specific | | Service Provider |
| DMRS | Reference Signal | | Language | EDN | Edge Data |
| DN | Data network | | Digital Subscriber | | Network |
| DNN | Data Network | | Line | EEC | Edge Enabler |
| | Name | DSLAM | DSL Access | | Client |
| eLAA | enhanced Licensed | | Multiplexer | EECID | Edge Enabler |
| | Assisted Access, | DwPTS | Downlink Pilot | | Client |
| | enhanced LAA | | Time Slot | | Identification |
| EM | Element Manager | E-LAN | Ethernet Local | EES | Edge Enabler |
| eMBB | Enhanced Mobile | | Area Network | | Server |
| | Broadband | E2E | End-to-End | EESID | Edge Enabler |
| EMS | Element Management | EAS | Edge Application | | Server |
| | System | | Server | | Identification |
| eNB | evolved NodeB, | ECCA | extended clear | EHE | Edge Hosting |
| E-UTRAN | Node B | | channel | | Environment |
| EN-DC | E-UTRA-NR Dual | | assessment | EGMF | Exposure |
| | Connectivity | | extended CCA | | Governance |
| EPC | Evolved Packet Core | ECCE | Enhanced Control | | Management |
| EPDCCH | enhanced PDCCH, | | Channel Element, | | Function |
| | enhanced Physical | | Enhanced CCE | EGPRS | Enhanced GPRS |
| | Downlink Control | ED | Energy Detection | EIR | Equipment |
| | Channel | EDGE | Enhanced Data- | | Identity Register |
| EPRE | Energy per resource | | rates for GSM | FB | Functional |
| | element | ETWS | Earthhquake and | | Block |
| EPS | Evolved Packet | | Tsunami | FBI | Feedback |
| | System | | Warning System | | Information |
| EREG | enhanced REG, | eUICC | embedded UICC, | FCC | Federal |
| | enhanced resource | | embedded | | Communications |
| | element groups | | Universal | | Commission |
| ETSI | European | | Integrated Circuit | FCCH | Frequency |
| | Telecommunication | | Card | | Correction |
| | Standards Institute | E-UTRA | Evolved UTRA | | CHannel |
| FQDN | Fully Qualified | E-UTRAN | Evolved UTRAN | FDD | Frequency |
| | Domain Name | EV2X | Enhanbced V2X | | Division Duplex |
| G-RNTI | GERAN Radio | F1AP | F1 Application | FDM | Frequency |
| | Network Temporary | | Protocol | | Division |
| | Identity | F1-C | F1 Control plane | | Multiplex |
| GERAN | GSM EDGE RAN, | | interface | FDMA | Frequency |
| | GSM EDGE Radio | F1-U | F1 User plane | | Division |
| | Access Network | | interface | | Multiple Access |
| GGSN | Gateway GPRS | FACCH | Fast Associated | FE | Front End |
| | Support Node | | Control CHannel | FEC | Forward Error |
| GLONASS | GLObal’naya | FACCH/F | Fast Associated | | Correction |
| | NAvigatsionnay | | Control Channel/ | FFS | For Further |
| | Sputnikovaya | | Full rate | | Study |
| | Sistema (Engl.: | FACCH/H | Fast Associated | FFT | Fast Fourier |
| | Global Navigation | | Control Channel/ | | Transformation |
| | Satellite System) | | Half rate | feLAA | further enhanced |
| gNB | Next Generation | FACH | FACH Forward | | Licensed Assisted |
| | NodeB | | Access Channel | | Access, further |
| gNB-CU | gNB-centralized | FAUSCH | Fast Uplink | | enhanced LAA |
| | unit, Next Generation | | Signalling | FN | Frame Number |
| | NodeB centralized | | Channel | FPGA | Field- |
| | unit | GNSS | Global | | Programmable |
| gNB-DU | gNB-distributed | | Navigation | | Gate Array |
| | unit, Next Generation | | Satellite System | FR | Frequency Range |
| | NodeB distributed | GPRS | General Packet | HLR | Home Location |
| | unit | | Radio Service | | Register |
| ICIC | Inter-Cell Interference | GPSI | Generic Public | HN | Home Network |
| | Coordination | | Subscription | HO | Handover |
| ID | Identity, identifier | | Identifier | HPLMN | Home Public |
| IDFT | Inverse Discrete | GSM | Global System | | Land Mobile |
| | Transform | | for Mobile | | Network |
| IE | Information element | | Communications, | HSDPA | High Speed |
| IBE | In-Band Emission | | Groupe Spécial | | Downlink |
| IEEE | Institute of Electrical | | Mobile | | Packet Access |
| | and Electronics | GTP | GPRS Tunneling | HSN | Hopping |
| | Engineers | | Protocol | | Sequence |
| IEI | Information Element | GTP- | Tunnelling | | Number |
| | Identifier | UGPRS | Protocol for | HSPA | High Speed |
| IEIDL | Information Element | | User Plane | | Packet Access |
| | Identifier Data Length | GTS | Go To Sleep | HSS | Home |
| IETF | Internet Engineering | | Signal (related | | Subscriber |
| | Task Force | | to WUS) | | Server |
| IF | Infrastructure | GUMMEI | Globally Unique | HSUPA | High Speed |
| IIOT | Industrial Internet of | | MME Identifier | | Uplink Packet |
| | Things | GUTI | Globally Unique | | Access |
| IM | Interference | | Temporary UE | HTTP | Hyper Text |
| | Measurement, | | Identity | | Transfer Protocol |
| | Intermodulation, IP | HARQ | Hybrid ARQ, | HTTPS | Hyper Text |
| | Multimedia | | Hybrid Automatic | | Transfer Protocol |
| IMC | IMS Credentials | | Repeat Request | | Secure (https is |
| ksps | kilo-symbols per | HANDO | Handover | | http/1.1 over |
| | second | HFN | HyperFrame | | SSL, i.e. port |
| KVM | Kernel Virtual | | Number | | 443) |
| | Machine | HHO | Hard Handover | I-Block | Information |
| L1 | Layer 1 (physical | IMEI | International | | Block |
| | layer) | | Mobile | ICCID | Integrated |
| L1-RSRP | Layer 1 reference | | Equipment | | Circuit Card |
| | signal received power | | Identity | | Identification |
| L2 | Layer 2 (data link | IMGI | International | IAB | Integrated |
| | layer) | | mobile group | | Access and |
| L3 | Layer 3 (network | | identity | | Backhual |
| | layer) | IMPI | IP Multimedia | ISDN | Integrated |
| LAA | Licensed Assisted | | Private Identity | | Services Digital |
| | Access | IMPU | IP Multimedia | | Network |
| LAN | Local Area Network | | PUbic identity | ISIM | IM Services |
| LADN | Local Area Data | IMS | IP Multimedia | | Identity Module |
| | Network | | Subsystem | ISO | International |
| LBT | Listen Before Talk | IMSI | International | | Organisation |
| LCM | LifeCycle | | Mobile | | for |
| | Management | | Subscriber | | Standardisation |
| LCR | Low Chip Rate | | Identity | ISP | Internet Service |
| LCS | Location Services | IoT | Internet of Things | | Provider |
| LCID | Logical Channel ID | IP | Internet Protocol | IWF | Interworking- |
| LI | Layer Indicator | Ipsec | IP Security, | | Function |
| LLC | Logical Link Control, | | Internet Protocol | I-WLAN | Interworking- |
| | Low Layer | | Security | | WLAN |
| | Compatibility | IP-CAN | IP-Connectivity | | Constraint length |
| LMF | Location Management | | Access Network | | of the |
| | Function | IP-M | IP Multicast | | convolutional |
| MDT | Minimization of | IPv4 | Internet Protocol | | code, USIM |
| | Drive Tests | | Version 4 | | Individual key |
| ME | Mobile Equipment | IPv6 | Internet Protocol | kB | Kilobyte (1000 |
| MeNB | master eNB | | Version 6 | | bytes) |
| MER | Message Error Ratio | IR | Infrared | kbps | kilo-bits per |
| MGL | Measurement Gap | IS | In Sync | | second |
| | Length | IRP | Integration | Kc | Ciphering key |
| MGRP | Measurement Gap | | Reference Point | Ki | Individual |
| | Repetition Period | LOS | Line of Sight | | subscriber |
| MIB | Master Information | LPLMN | Local PLMN | | authentication |
| | Block, Management | LPP | LTE Positioning | | key |
| | Information Base | | Protocol | KPI | Key |
| MIMO | Multiple Input | LSB | Least Significant | | Performance |
| | Multiple Output | | Bit | | Indicator |
| MLC | Mobile Location | LTE | Long Term | KQI | Key Quality |
| | Centre | | Evolution | | Indicator |
| MM | Mobility Management | LWA | LTE-WLAN | KSI | Key Set |
| MME | Mobility Management | | aggregation | | Identifier |
| | Entity | LWIP | LTE/WLAN | MAC- | used for data |
| MN | Master Node | | Radio Level | IMAC | integrity of |
| MNO | Mobile Network | | Integration with | | signalling |
| | Operator | | IPsec Tunnel | | messages (TSG |
| MO | Measurement Object, | LTE | Long Term | | T WG3 context) |
| | Mobile Originated | | Evolution | MANO | Management |
| MPBCH | MTC Physical | M2M | Machine-to- | | and Orchestration |
| | Broadcast CHannel | | Machine | MBMS | Multimedia |
| MPDCCH | MTC Physical | MAC | Medium Access | | Broadcast and |
| | Downlink | | Control (protocol | | Multicast |
| NEF | Network Exposure | | layering context) | | Service |
| | Function | MAC | Message | MBSFN | Multimedia |
| NF | Network Function | | authentication | | Broadcast |
| NFP | Network Forwarding | | code (security/ | | service Single |
| | Path | | encryption | | Frequency |
| NFPD | Network Forwarding | | context) | | Network |
| | Path Descriptor | MAC-A | MAC used for | MCC | Mobile Country |
| NFV | Network Functions | | authentication | | Code |
| | Virtualization | | and key agreement | MCG | Master Cell |
| NFVI | NFV Infrastructure | | (TSG T WG3 | | Group |
| NFVO | NFV Orchestrator | | context) Control | MCOT | Maximum |
| NG | Next Generation, | | CHannel | | Channel |
| | Next Gen | MPDSCH | MTC Physical | | Occupancy |
| NGEN | NG-RAN E-UTRA- | | Downlink Shared | | Time |
| | NR Dual Connectivity | | CHannel | MCS | Modulation |
| NM | Network Manager | MPRACH | MTC Physical | | and coding |
| NMS | Network Management | | Random Access | | scheme |
| | System | | CHannel | MDAF | Management |
| N-PoP | Network Point of | MPUSCH | MTC Physical | | Data Analytics |
| | Presence | | Uplink Shared | | Function |
| NMIB, | Narrowband MIB | | Channel | MDAS | Management |
| N-MIB | | MPLS | MultiProtocol | | Data Analytics |
| NPBCH | Narrowband Physcial | | Label Switching | | Service |
| | Broadcast CHannel | MS | Mobile Station | MT | Mobile |
| OPEX | OPerating EXpense | MSB | Most Significant | | Terminated, |
| OSI | Other System | | Bit | | Mobile |
| | Information | MSC | Mobile Switching | | Termination |
| OSS | Operations Support | | Centre | MTC | Machine-Type |
| | System | MSI | Minium System | | Communications |
| OTA | over-the-air | | Information, | mMTC | massive MTC, |
| PAPR | Peak-to-Average | | MCH Scheduling | | massive |
| | Power Ratio | | Information | | Machine-Type |
| PAR | Peak to Average | MSID | Mobile Station | | Communications |
| | Ratio | | Identifier | MU- | Multi User |
| PBCH | Physical Broadcast | | Number | MIMO | MIMO |
| | Channel | MSISDN | Mobile | MWUS | MTC wake-up |
| PC | Power Control, | | Subscribor ISDN | | signal, MTC |
| | Personal Computer | | Number | | WUS |
| PCC | Primary Component | NPDCCH | Narrowband | NACK | Negative |
| | Carrier, Primary CC | | Physical Downlink | | Acknowledgement |
| P-CSCF | Proxy CSCF | | Control CHannel | NAI | Network Access |
| PCell | Primary Cell | NPDSCH | Narrowband | | Identifier |
| PCI | Physical Cell Identity | | Physical Downlink | NAS | Non-Access |
| PCEF | Policy and Charging | | Access CHannel | | Stratum, Non- |
| | Enforcement Function | NPUSCH | Narrowband | | Access Stratum |
| PCF | Policy Control | | Physcial Uplink | | layer |
| | Function | | Shared CHannel | NCT | Network |
| PCRF | Policy Control and | NPSS | Narrowband | | Connectivity |
| | Charging Rules | | Primary | | Topology |
| | Function | | Synchronization | NC-JT | Non-Coherent |
| PSDCH | Physical Sidelink | | Signal | | Joint Transmission |
| | Downlink Channel | NSSS | Narrowband | NEC | Network |
| PSCCH | Physical Sidelink | | Secondary | | Capability |
| | Control Channel | | Synchronization | | Exposure |
| PSSCH | Physical Sidelink | | Signal | NE-DC | NR-E-UTRA |
| | Shared Channel | NR | New Radio, | | Dual |
| PSCell | Primary SCell | | Neighbour | | Connectivity |
| PSS | Primary | | Relation | NSA | Non-Standalone |
| | Synchronization | NRF | NF Repository | | operation mode |
| | Signal | | Function | NSD | Network Service |
| PSTN | Public Switched | NRS | Narrowband | | Descriptor |
| | Telephone Network | | Reference Signal | NSR | Network Service |
| PT-RS | Phase-tracking | NS | Network Service | | Record |
| | reference signal | PDCP | Packet Data | NSSAI | Network Slice |
| PTT | Push-to-Talk | | Convergence | | Selection |
| PUCCH | Physical Uplink | | Protocol, Packet | | Assistance |
| | Control Channel | | Data Convergence | | Information |
| PUSCH | Physical Uplink | | Protocol layer | S- | Single NSSAI |
| | Shared Channel | PDCCH | Physical Down- | NNSAI | |
| QAM | Quadrature | | link Control | NSSF | Network Slice |
| | Amplitude | | Channel | | Selection |
| | Modulation | PDCP | Packet Data | | Function |
| QCI | QoS class of | | Convergence | NW | Network |
| | identifier | | Protocol | NWUS | Narrowband |
| QCL | Quasi co-location | PDN | Packet Data | | wake-up signal, |
| QFI | QoS Flow ID, QoS | | Network, Public | | Narrowband |
| | Flow Identifier | | Data Network | | WUS |
| RNL | Radio Network Layer | PDSCH | Physical Down- | NZP | Non-Zero Power |
| RNTI | Radio Network | | link Shared | O&M | Opoeration and |
| | Temporary | | Channel | | Maintenance |
| | Identifier | PDU | Protocol Data | ODU2 | Optical channel |
| ROHC | RObust Header | | Unit | | Data Unit-type 2 |
| | Compression | PEI | Permanent | OFDM | Orthogonal |
| RRC | Radio Resource | | Equipment | | Frequency |
| | Control, Radio | | Identifiers | | Division |
| | Resource Control | PFD | Packet Flow | | Multiplexing |
| | layer | | Description | OFDMA | Orthogonal |
| RRM | Radio Resource | P-GW | PDN Gateway | | Frequency |
| | Management | PHICH | Physical hybrid- | | Division Multiple |
| RS | Reference Signal | | ARQ indicator | | Access |
| RSRP | Reference Signal | | channel | OOB | Out-of-band |
| | Received Power | PHY | Physical layer | OOS | Out of Sync |
| RSRQ | Reference Signal | PLMN | Public Land | PMI | Precoding Matrix |
| | Received Quality | | Mobile Network | | Indicator |
| RSSI | Received Signal | PIN | Personal | PNF | Physical Network |
| | Strength Indicator | | Identification | | Function |
| RSU | Road Slide Unit | | Number | PNFD | Physical Network |
| RSTD | Reference Signal | PM | Performance | | Function |
| | Time difference | | Measurement | | Descriptor |
| RTP | Real Time Protocol | QoS | Quality of Service | PNFR | Physical Network |
| RTS | Ready-To-Send | QPSK | Quadrature | | Record |
| RTT | Round Trip Time | | (Quaternary) Phase | POC | PTT over Cellular |
| Rx | Reception, Receiving, | | Shift Keying | PP, PTP | Point-to-Point |
| | Receiver | QZSS | Quasi-Zenith | PPP | Point-to-Point |
| SDU | Service Data Unit | | Satellite System | | Protocol |
| SEAF | Security Anchor | RA-RNTI | Random Access | PRACH | Physical RACH |
| | Function | | RNTI | PRB | Physical resource |
| SeNB | secondary eNB | RAB | Radio Access | | block |
| SEPP | Security Edge | | Bearer, Random | PRG | Physical resource |
| | Protection Proxy | | Access Burst | | block group |
| SFI | Slot format indication | RACH | Random Access | ProSe | Prosimity |
| SFTD | Space-Frequency | | Channel | | Services, |
| | Time Diversity, SFN | RADIUS | Remote | | Proximity-Based |
| | and frame timing | | Authentication | | Service |
| | difference | | Dial In User | PRS | Positioning |
| SFN | System Frame | | Service | | Reference Signal |
| | Number | RAN | Radio Access | PRR | Packet Reception |
| SgNB | Secondary gNB | | Network | | Radio |
| SGSN | Serving GPRS | RAND | RANDom number | PS | Packet Services |
| | Support Node | | (used for | PSBCH | Physical |
| S-GW | Serving Gateway | | authentication) | | Sidelink |
| SI | System Information | RAR | Random Access | | Broadcast |
| SI-RNTI | System Information | | Response | | Channel |
| | RNTI | RAT | Radio Access | REQ | REQuest |
| SIB | System Information | | Technology | RF | Radio Frequency |
| | Block | RAU | Routing Area | RI | Rank Indicator |
| SIM | Subscriber Identity | | Update | RIV | Resource |
| | Module | RB | Resource block, | | indicator value |
| SIP | Session Initiated | | Radio Bearer | RL | Radio Link |
| | Protocol | RBG | Resource block | RLC | Radio Link |
| SiP | System in Package | | group | | Control, Radio |
| SL | Sidelink | REG | Resource Element | | Link Control |
| SSSIF | Search Space Set | | Group | | layer |
| | Indicator | Rel | Release | RLC | RLC |
| SST | Slice/Service Types | S1AP | S1 Application | UM | Unacknowledged |
| SU-MIMO | Single User MIMO | | Protocol | | Mode |
| SUL | Supplementary | S1-MME | S1 for the control | RLF | Radio Link |
| | Uplink | | plane | | Failure |
| TA | Timing Advance, | S1-U | S1 for the user | RLM | Radio Link |
| | Tracking Area | | plane | | Monitoring |
| TAC | Tracking Area Code | S-CSCF | serving CSCF | RLM- | Reference Signal |
| TAG | Timing Advance | S-GW | Serving Gateway | RS | for RLM |
| | Group | S-RNTI | SRNC Radio | RM | Registration |
| TAI | Tracking Area | | Network | | Management |
| | Identity | | Temporary | RMC | Reference |
| TAU | Tracking Area | | Identity | | Measurement |
| | Update | S-TMSI | SAE Temporary | | Channel |
| TB | Transport Block | | Mobile Station | RMSI | Remaining MSI, |
| TBS | Transport Block Size | | Identifier | | Remaining |
| TBD | To Be Defined | SA | Standalone | | Minimum System |
| TCI | Transmission | | operation mode | | Information |
| | Configuration | SAE | System | RN | Relay Node |
| | Indicator | | Architecture | RNC | Radio Network |
| TCP | Transmission | | Evolution | | Controller |
| | Communication | SAP | Service Access | SCEF | Service |
| | Protocol | | Point | | Capability |
| TDD | Time Division | SAPD | Service Access | | Exposure Function |
| | Duplex | | Point Descriptor | SC- | Single Carrier |
| TDM | Time Division | SAPI | Service Access | FDMA | Frequency |
| | Multiplexing | | Point Identifier | | Division Multiple |
| UPF | User Plane Function | SCC | Secondary | | Access |
| URI | Uniform Resource | | Component Carrier, | SCG | Secondary Cell |
| | Identifier | | Secondary CC | | Group |
| URL | Uniform Resource | SCell | Secondary Cell | SCM | Security Context |
| | Locator | SLA | Service Level | | Management |
| URLLC | Ultra-Reliable and | | Agreement | SCS | Subcarrier |
| | Low Latency | SM | Session | | Spacing |
| USB | Universal Serial Bus | | Management | SCTP | Stream Control |
| USIM | Universal Subscriber | SMF | Session | | Transmission |
| | Identity Module | | Management | | Protocol |
| USS | UE-specific search | | Function | SDAP | Service Data |
| | space | SMS | Short Message | | Adaptation |
| UTRA | UMTS Terrestrial | | Service | | Protocol, Service |
| | Radio Access | SMSF | SMS Function | | Data Adaptation |
| UTRAN | Universal Terrestrial | SMTC | SSB-based | | Protocol layer |
| | Radio Access | | Measurement | SDL | Supplementary |
| | Network | | Timing | | Downlink |
| UwPTS | Uplink Pilot Time | | Configuration | SDNF | Structured Data |
| | Slot | SN | Secondary Node, | | Storage Network |
| V2I | Vehicle-to- | | Sequence Number | | Function |
| | Infrastruction | SoC | Sysem on Chip | SDP | Session |
| V2P | Vehicle-to- | SON | Self-organizing | | Description |
| | Pedestrian | | Network | | Protocol |
| V2V | Vehicle-to-Vehicle | SpCell | Special Cell | SDSF | Structured Data |
| V2X | Vehicle-to-everything | SP-CSI- | Semi-Persistent | | Storage Function |
| | | RNTI | CSI RNTI | SDT | Small Data |
| | | SPS | Semi-Persistent | | Transmission |
| | | | Scheduling | SSID | Service Set |
| | | SQN | Sequence number | | Identifier |
| | | SR | Scheduling Request | SS/ | Block SSBRI SS/ |
| | | SRB | Signalling Radio | PBCH | PBCH Block |
| | | | Bearer | | Resource |
| | | SRS | Sounding | | Indicator, |
| | | | Reference Signal | | Synchronization |
| | | SS | Synchronization | | Signal Block |
| | | | Signal | | Resource |
| | | SSB | Synchronization | | Indicator |
| | | | Signal Block | SSC | Session and |
| | | TDMA | Time Division | | Service |
| | | | Multiple Access | | Continuity |
| | | TE | Terminal | SS- | Synchronization |
| | | | Equipment | RSRP | Signal based |
| | | TEID | Tunnel End | | Reference Signal |
| | | | Point Identifier | | Received Power |
| | | TFT | Traffic Flow | SS- | Synchronization |
| | | | Template | RSRQ | Signal based |
| | | TMSI | Temporary | | Reference Signal |
| | | | Mobile Subscriber | | Received Quality |
| | | | Identity | SS- | Synchronization |
| | | TNL | Transport Network | SINR | Signal based |
| | | | Layer | | Signal to Noise |
| | | TPC | Transmit Power | | and Interference |
| | | | Control | | Ratio |
| | | TPMI | Transmitted | SSS | Secondary |
| | | | Precoding Matrix | | Synchronization |
| | | | Indicator | | Signal |
| | | TR | Technical Report | SSSG | Search Space |
| | | TRP, | Transmission | | Set Group |
| | | TRxp | Reception Point | Tx | Transmission, |
| | | TRS | Tracking Reference | | Transmitting, |
| | | | Signal | | Transmitter |
| | | TRx | Transceiver | U-RNTI | UTRAN Radio |
| | | TC | Technical | | Network |
| | | | Specifications, | | Temporary |
| | | | Technical | | Identity |
| | | | Standard | UART | Universal |
| | | TTI | Transmission | | Asynchronous |
| | | | Time Interval | | Receiver and |
| | | VIM | Virtualized | | Transmitter |
| | | | Infrastructure | UCI | Uplink Control |
| | | | Manager | | Information |
| | | VL | Virtual Link | UE | User Equipment |
| | | VLAN | Virtual LAN, | UDM | Unified Data |
| | | | Virtual Local Area | | Management |
| | | | Network | UDP | User Datagram |
| | | VM | Virtual Machine | | Protocol |
| | | VNF | Virtualized | UDSF | Unstructured Data |
| | | | Network | | Storage Network |
| | | | Function | | Function |
| | | VNFFG | VNF Forwarding | UICC | Universal |
| | | | Graph | | Integrated Circuit |
| | | VNFFGD | VNF Forwarding | | Card |
| | | | Graph Descriptor | UL | Uplink |
| | | VNFM | VNF Manager | UM | Unacknowledged |
| | | VoIP | Voice-over-IP, | | Mode |
| | | | Voice-over- | UML | Unified Modelling |
| | | | Internet Protocol | | Language |
| | | VPLMN | Visited Public | UMTS | Universal Mobile |
| | | | Land Mobile | | Tele- |
| | | | Network | | communications |
| | | VPN | Virtual Private | | System |
| | | | Network | UP | User Plane |
| | | VRB | Virtual Resource | WMAN | Wireless |
| | | | Block | | Metropolitan |
| | | WiMAX | Worldwide | | Area Network |
| | | | Interoperability | WPAN | Wireless Personal |
| | | | for Microwave | | Area Network |
| | | | Access | X2-C | X2-Control plane |
| | | WLAN | Wireless Local | X2-U | X2-User plane |
| | | | Area Network | XML | eXtensible |
| | | | | | Markup |
| | | | | | Language |
| | | | | XRES | EXpected user |
| | | | | | RESponse |
| | | | | XOR | eXclusive OR |
| | | | | ZC | Zadoff-Chu |
| | | | | ZP | Zero Power |

### Terminology

For the purposes of the present document, the following terms and definitions are applicable to the examples and embodiments discussed herein.

The term “circuitry” as used herein refers to, is part of, or includes hardware components such as an electronic circuit, a logic circuit, a processor (shared, dedicated, or group) and/or memory (shared, dedicated, or group), an Application Specific Integrated Circuit (ASIC), a field-programmable device (FPD) (e.g., a field-programmable gate array (FPGA), a programmable logic device (PLD), a complex PLD (CPLD), a high-capacity PLD (HCPLD), a structured ASIC, or a programmable SoC), digital signal processors (DSPs), etc., that are configured to provide the described functionality. In some embodiments, the circuitry may execute one or more software or firmware programs to provide at least some of the described functionality. The term “circuitry” may also refer to a combination of one or more hardware elements (or a combination of circuits used in an electrical or electronic system) with the program code used to carry out the functionality of that program code. In these embodiments, the combination of hardware elements and program code may be referred to as a particular type of circuitry.

The term “processor circuitry” as used herein refers to, is part of, or includes circuitry capable of sequentially and automatically carrying out a sequence of arithmetic or logical operations, or recording, storing, and/or transferring digital data. Processing circuitry may include one or more processing cores to execute instructions and one or more memory structures to store program and data information. The term “processor circuitry” may refer to one or more application processors, one or more baseband processors, a physical central processing unit (CPU), a single-core processor, a dual-core processor, a triple-core processor, a quad-core processor, and/or any other device capable of executing or otherwise operating computer-executable instructions, such as program code, software modules, and/or functional processes. Processing circuitry may include more hardware accelerators, which may be microprocessors, programmable processing devices, or the like. The one or more hardware accelerators may include, for example, computer vision (CV) and/or deep learning (DL) accelerators. The terms “application circuitry” and/or “baseband circuitry” may be considered synonymous to, and may be referred to as, “processor circuitry.”

The term “interface circuitry” as used herein refers to, is part of, or includes circuitry that enables the exchange of information between two or more components or devices. The term “interface circuitry” may refer to one or more hardware interfaces, for example, buses, I/O interfaces, peripheral component interfaces, network interface cards, and/or the like.

The term “user equipment” or “UE” as used herein refers to a device with radio communication capabilities and may describe a remote user of network resources in a communications network. The term “user equipment” or “UE” may be considered synonymous to, and may be referred to as, client, mobile, mobile device, mobile terminal, user terminal, mobile unit, mobile station, mobile user, subscriber, user, remote station, access agent, user agent, receiver, radio equipment, reconfigurable radio equipment, reconfigurable mobile device, etc. Furthermore, the term “user equipment” or “UE” may include any type of wireless/wired device or any computing device including a wireless communications interface.

The term “network element” as used herein refers to physical or virtualized equipment and/or infrastructure used to provide wired or wireless communication network services. The term “network element” may be considered synonymous to and/or referred to as a networked computer, networking hardware, network equipment, network node, router, switch, hub, bridge, radio network controller, RAN device, RAN node, gateway, server, virtualized VNF, NFVI, and/or the like.

The term “computer system” as used herein refers to any type interconnected electronic devices, computer devices, or components thereof. Additionally, the term “computer system” and/or “system” may refer to various components of a computer that are communicatively coupled with one another. Furthermore, the term “computer system” and/or “system” may refer to multiple computer devices and/or multiple computing systems that are communicatively coupled with one another and configured to share computing and/or networking resources.

The term “appliance,” “computer appliance,” or the like, as used herein refers to a computer device or computer system with program code (e.g., software or firmware) that is specifically designed to provide a specific computing resource. A “virtual appliance” is a virtual machine image to be implemented by a hypervisor-equipped device that virtualizes or emulates a computer appliance or otherwise is dedicated to provide a specific computing resource.

The term “resource” as used herein refers to a physical or virtual device, a physical or virtual component within a computing environment, and/or a physical or virtual component within a particular device, such as computer devices, mechanical devices, memory space, processor/CPU time, processor/CPU usage, processor and accelerator loads, hardware time or usage, electrical power, input/output operations, ports or network sockets, channel/link allocation, throughput, memory usage, storage, network, database and applications, workload units, and/or the like. A “hardware resource” may refer to compute, storage, and/or network resources provided by physical hardware element(s). A “virtualized resource” may refer to compute, storage, and/or network resources provided by virtualization infrastructure to an application, device, system, etc. The term “network resource” or “communication resource” may refer to resources that are accessible by computer devices/systems via a communications network. The term “system resources” may refer to any kind of shared entities to provide services, and may include computing and/or network resources. System resources may be considered as a set of coherent functions, network data objects or services, accessible through a server where such system resources reside on a single host or multiple hosts and are clearly identifiable.

The term “channel” as used herein refers to any transmission medium, either tangible or intangible, which is used to communicate data or a data stream. The term “channel” may be synonymous with and/or equivalent to “communications channel,” “data communications channel,” “transmission channel,” “data transmission channel,” “access channel,” “data access channel,” “link,” “data link,” “carrier,” “radiofrequency carrier,” and/or any other like term denoting a pathway or medium through which data is communicated. Additionally, the term “link” as used herein refers to a connection between two devices through a RAT for the purpose of transmitting and receiving information.

The terms “instantiate,” “instantiation,” and the like as used herein refers to the creation of an instance. An “instance” also refers to a concrete occurrence of an object, which may occur, for example, during execution of program code.

The terms “coupled,” “communicatively coupled,” along with derivatives thereof are used herein. The term “coupled” may mean two or more elements are in direct physical or electrical contact with one another, may mean that two or more elements indirectly contact each other but still cooperate or interact with each other, and/or may mean that one or more other elements are coupled or connected between the elements that are said to be coupled with each other. The term “directly coupled” may mean that two or more elements are in direct contact with one another. The term “communicatively coupled” may mean that two or more elements may be in contact with one another by a means of communication including through a wire or other interconnect connection, through a wireless communication channel or link, and/or the like.

The term “information element” refers to a structural element containing one or more fields. The term “field” refers to individual contents of an information element, or a data element that contains content.

The term “SMTC” refers to an SSB-based measurement timing configuration configured by SSB-Measurement TimingConfiguration.

The term “SSB” refers to an SS/PBCH block.

The term “a “Primary Cell” refers to the MCG cell, operating on the primary frequency, in which the UE either performs the initial connection establishment procedure or initiates the connection re-establishment procedure.

The term “Primary SCG Cell” refers to the SCG cell in which the UE performs random access when performing the Reconfiguration with Sync procedure for DC operation.

The term “Secondary Cell” refers to a cell providing additional radio resources on top of a Special Cell for a UE configured with CA.

The term “Secondary Cell Group” refers to the subset of serving cells comprising the PSCell and zero or more secondary cells for a UE configured with DC.

The term “Serving Cell” refers to the primary cell for a UE in RRC_CONNECTED not configured with CA/DC there is only one serving cell comprising of the primary cell.

The term “serving cell” or “serving cells” refers to the set of cells comprising the Special Cell(s) and all secondary cells for a UE in RRC_CONNECTED configured with CA/.

The term “Special Cell” refers to the PCell of the MCG or the PSCell of the SCG for DC operation; otherwise, the term “Special Cell” refers to the Pcell.

1.-40. (canceled)

41. An apparatus for use in a user equipment (UE), wherein the apparatus comprises:
memory to store a received downlink control information (DCI) that schedules a plurality of physical downlink shared channels (PDSCHs) in a plurality of serving cells; and
one or more processors configured to:
identify a reference serving cell of the plurality of serving cells;
identify, based on the DCI, a counter downlink assignment index (DAI); and
encode, based on the counter DAI and the reference serving cell, hybrid automatic repeat request acknowledgement (HARQ-ACK) feedback for the plurality of PDSCHs.

42. The apparatus of claim 41, wherein identification of the reference serving cell of the plurality of serving cells is based on respective serving cell indexes of respective serving cells of the plurality of serving cells.

43. The apparatus of claim 42, wherein the reference serving cell is a serving cell with a smallest serving cell index of the plurality of serving cells.

44. The apparatus of claim 41, wherein a value of the counter DAI field denotes an accumulative number of {reference serving cell, physical downlink control channel (PDCCH)} pairs in which PDSCH receptions are present up to a current reference serving cell and current PDCCH monitoring occasion.

45. The apparatus of claim 44, wherein the counter DAI is counted first, if the UE supports more than one PDSCH reception on a serving cell that are scheduled from a same PDCCH monitoring occasion, in increasing order of a PDSCH reception starting time for a same {reference serving cell, PDCCH monitoring occasion} pair.

46. The apparatus of claim 44, wherein the counter DAI is counted second in ascending order of reference serving cell index.

47. The apparatus of claim 44, wherein the counter DAI is counted third in ascending order of PDCCH monitoring occasion index m, where 0≤m<M.

48. One or more non-transitory computer-readable media (NTCRM) comprising instructions that, upon execution of the instructions by one or more processors, are to cause a user equipment (UE) to:
identify a received downlink control information (DCI) that schedules a plurality of physical downlink shared channels (PDSCHs) in a plurality of serving cells;
identify a reference serving cell of the plurality of serving cells;
identify, based on the DCI, a counter downlink assignment index (DAI); and
encode, based on the counter DAI and the reference serving cell, hybrid automatic repeat request acknowledgement (HARQ-ACK) feedback for the plurality of PDSCHs.

49. The one or more NTCRM of claim 48, wherein identification of the reference serving cell of the plurality of serving cells is based on respective serving cell indexes of respective serving cells of the plurality of serving cells.

50. The one or more NTCRM of claim 49, wherein the reference serving cell is a serving cell with a smallest serving cell index of the plurality of serving cells.

51. The one or more NTCRM of claim 48, wherein a value of the counter DAI field denotes an accumulative number of {reference serving cell, physical downlink control channel (PDCCH)} pairs in which PDSCH receptions are present up to a current reference serving cell and current PDCCH monitoring occasion.

52. The one or more NTCRM of claim 50, wherein the counter DAI is counted first, if the UE supports more than one PDSCH reception on a serving cell that are scheduled from a same PDCCH monitoring occasion, in increasing order of a PDSCH reception starting time for a same {reference serving cell, PDCCH monitoring occasion} pair.

53. The one or more NTCRM of claim 50, wherein the counter DAI is counted second in ascending order of reference serving cell index.

54. The one or more NTCRM of claim 50, wherein the counter DAI is counted third in ascending order of PDCCH monitoring occasion index m, where 0≤m<M.

55. One or more non-transitory computer-readable media (NTCRM) comprising instructions that, upon execution of the instructions by one or more processors, are to cause a base station to:
identify a reference serving cell of a plurality of serving cells;
identify, based on the reference serving cell, a counter downlink assignment index (DAI);
encode, for transmission to a user equipment (UE), a downlink control information (DCI) that schedules a plurality of physical downlink shared channels (PDSCHs) in a plurality of serving cells, wherein the DCI includes an indication of the counter DAI; and
identify, from the UE based on the counter DAI, hybrid automatic repeat request acknowledgement (HARQ-ACK) feedback for the plurality of PDSCHs.

56. The one or more NTCRM of claim 55, wherein identification of the reference serving cell of the plurality of serving cells is based on respective serving cell indexes of respective serving cells of the plurality of serving cells.

57. The one or more NTCRM of claim 56, wherein the reference serving cell is a serving cell with a smallest serving cell index of the plurality of serving cells.

58. The one or more NTCRM of claim 55, wherein a value of the counter DAI field denotes an accumulative number of {reference serving cell, physical downlink control channel (PDCCH)} pairs in which PDSCH receptions are present up to a current reference serving cell and current PDCCH monitoring occasion.

59. The one or more NTCRM of claim 58, wherein the counter DAI is counted first, if the UE supports more than one PDSCH reception on a serving cell that are scheduled from a same PDCCH monitoring occasion, in increasing order of a PDSCH reception starting time for a same {reference serving cell, PDCCH monitoring occasion} pair.

60. The one or more NTCRM of claim 58, wherein the counter DAI is counted second in ascending order of reference serving cell index.
